(19) United States
(12) Patent Application Publication
(10) Pub. No.: US 2016/0237319 A1
(43) Pub. Date: Aug. 18, 2016

(54) OPTICAL FILM WITH PRESSURE SENSITIVE ADHESIVE AND IMAGE DISPLAY DEVICE

(71) Applicant: NITTO DENKO CORPORATION, Osaka (JP)

(72) Inventors: Shou TAKARADA, Osaka (JP); Masaki MIZUTANI, Osaka (JP); Atsushi YASUI, Osaka (JP); Shinya YAMAMOTO, Osaka (JP)

(73) Assignee: NITTO DENKO CORPORATION, Osaka (JP)

(21) Appl. No.: 15/042,690

(22) Filed: Feb. 12, 2016

(30) Foreign Application Priority Data
Feb. 16, 2015 (JP) 2015-027241

(51) Int. Cl. C09J 7/02; B32B 27/26; B32B 27/30; G02B 5/30; B32B 27/08

(52) U.S. Cl. CPC C09J 7/0217; G02B 5/3025; B32B 27/08; B32B 27/30; B32B 27/26; C09J 133/08

(57) ABSTRACT

The optical film with pressure sensitive adhesive comprises an optical film and a front-side pressure sensitive adhesive sheet. The front-side pressure sensitive adhesive sheet is a laminated pressure sensitive adhesive sheet and includes a first pressure sensitive adhesive layer disposed in contact with the optical film, and a second pressure sensitive adhesive layer disposed at the furthest from the optical film. The first pressure sensitive adhesive layer has a storage elastic modulus of 9×10³ Pa or less at 150° C., and a ratio G′₂₀/G′₁₅₀ of 20 or more, where G′₂₀ is a storage elastic modulus at 20° C. and G′₁₅₀ is a storage elastic modulus at 150° C. The second pressure sensitive adhesive layer has a storage elastic modulus of 4×10⁵ Pa or less at 20° C., and a storage elastic modulus of 1×10⁴ Pa or more at 150° C.

### TECHNICAL FIELD

The present invention relates to a pressure sensitive adhesive sheet and an optical film with pressure sensitive adhesive, which are suitably used for formation of an image display device including a transparent plate, a touch panel, or the like on the front surface of an image display panel. The present invention also relates to an image display device using the pressure sensitive adhesive sheet or the optical film with pressure sensitive adhesive.

### BACKGROUND ART

Liquid crystal displays and organic EL displays are widely used as various kinds of image display devices of mobile phones, car navigation devices, personal computer monitors, televisions and so on. On a viewing-side outermost surface of an image display panel, a front transparent plate (also referred to as a “window layer” etc.) such as a transparent resin plate or a glass plate may be provided, for the purpose of, for example, preventing damage to the image display panel due to impact from the outer surface. In addition, display devices provided with a touch panel on front surface of an image display panel become common recently.

For arranging a front transparent member such as front transparent plate and touch panel on a front surface of an image display panel, an “interlayer filling structure” is employed in which the front transparent member and the image display panel are bonded with pressure sensitive adhesive layer therebetween. In the interlayer filling structure, a gap between the panel and the front transparent member is filled with pressure sensitive adhesive to decrease a refractive index difference at the interface, and therefore deterioration of visibility due to reflection and scattering is suppressed. A colored layer intended for decoration and light shielding is formed at the peripheral edge of the front transparent member on the image display panel-side surface, thereby generating a printing level difference of about 10 μm to several tens μm. When a sheet pressure sensitive adhesive is used as an interlayer filler, the pressure sensitive adhesive cannot sufficiently penetrate to the vicinity of a printing level difference, and thus bubbles may remain to reduce the visibility of the screen image.

For solving problems caused by a printing level difference as described above, a thick and soft pressure sensitive adhesive sheet is used for bonding front transparent members, so that printing level difference absorbency is imparted. For example, WO 2010/04229 and JP-A-2011-219665 describe that the storage elastic modulus of a pressure sensitive adhesive layer to be used for bonding an optical film and a front transparent plate is made to fall within a specific range. JP-A-2011-74308 and JP-A-2013-6892 describe that a pressure sensitive adhesive sheet having small residual stress in a tensile stress relaxation test is excellent in level difference absorbency.

When a pressure sensitive adhesive sheet which soft (has a low storage elastic modulus and small residual stress) and has a large thickness is used as described above, generation of bubbles in the vicinity of a printing level difference can be suppressed. On the other hand, when the pressure sensitive adhesive is soft, bubbles are apt to remain at the interface between the front transparent member and the pressure sensitive adhesive sheet. In recent years, front transparent plates made of resin such as acrylic or polycarbonate have come into use in view of weight saving and flexibility, and thus the problem has become apparent that outgas generated by heating remains as bubbles at the interface between the front transparent plate and the pressure sensitive adhesive sheet.

WO 2010/04229 and JP-A-2011-219665 disclose a laminated pressure sensitive adhesive sheet obtained by laminating two pressure sensitive adhesive layers having different storage elastic moduli. When a pressure sensitive adhesive layer having a relatively high storage elastic modulus is bonded to a front transparent plate, both the problem that bubbles remain in the vicinity of a printing level difference and the problem that outgas from the front transparent plate remains as bubbles in the vicinity of the interface can be solved.

### SUMMARY OF THE INVENTION

### Problems to be Solved by the Invention

When the laminated pressure sensitive adhesive sheet disclosed in WO 2010/04229 and JP-A-2011-219665 is used for bonding an image display panel and a front plate or a touch panel, bubbles in the vicinity of a printing level difference and at the interface can be reduced. However, using the laminated pressure sensitive adhesive sheet may cause a problem that display unevenness occurs at the peripheral edge portion of a screen.

In view of the above, problems to be solved is reducing outgas retention and suppressing visibility reduction due to display unevenness and cloudiness of a pressure sensitive adhesive, even when a front transparent plate having a printing level difference is bonded to each other with a pressure sensitive adhesive. An object of the present invention is providing a pressure sensitive adhesive sheet and an optical film with pressure sensitive adhesive including the pressure sensitive adhesive sheet.

### Means for Solving the Problems

The present invention relates to a laminated pressure sensitive adhesive sheet. The pressure sensitive sheet is suitably used for bonding an image display panel and a front transparent member such as a transparent plate or a touch panel. The present invention also relates to an optical film with pressure sensitive adhesive, which includes the laminated pressure sensitive adhesive sheet on an optical film. When the storage elastic modulus of each of the pressure sensitive adhesive layers in the laminated pressure sensitive adhesive sheet is in a specific range and the pressure sensitive adhesive layer provided on the optical film side has a specific temperature dependency of storage elastic modulus, display unevenness can be suppressed.

The optical film with pressure sensitive adhesive according to the present invention includes a front-side pressure sensitive adhesive sheet on one surface of an optical film. The optical film includes a polarizing plate. The front-side pressure sensitive adhesive sheet is a laminated pressure sensitive adhesive sheet including at least two pressure sensitive adhesive layers laminated on each other. The pressure sensitive adhesive sheet includes a first pressure sensitive adhesive layer disposed in contact with the optical film, and a second pressure sensitive adhesive layer disposed at the furthest from the optical film.

The first pressure sensitive adhesive layer has a storage elastic modulus of 9×10³ Pa or less at 150° C., and a ratio G′₂₀/G′₁₅₀ of 20 or more, where G′₂₀ is a storage elastic modulus at 20° C. and G′₁₅₀ is a storage elastic modulus at 150° C. The second pressure sensitive adhesive layer has a storage elastic modulus of 4×10⁵ Pa or less at 20° C., and a storage elastic modulus of 1×10⁴ Pa or more at 150° C. Preferably, the front-side pressure sensitive adhesive sheet has a storage elastic modulus of 9×10³ Pa or less at 150° C.

In the laminated pressure sensitive adhesive sheet according to the present invention, the second pressure sensitive adhesive layer has a high storage elastic modulus at a high temperature. When the second pressure sensitive adhesive layer is bonded to the front transparent member, remaining of bubbles at the interface between the transparent member and the pressure sensitive adhesive sheet can be suppressed even if outgas is generated from the front transparent member by heating. Further, the first pressure sensitive adhesive layer disposed on the optical film side has a high temperature dependency of storage elastic modulus, and is excellent in level difference absorbency, so that ingress of bubbles in the vicinity of the level difference is suppressed. Therefore, display unevenness in the image display device can be suppressed.

The gel fraction of a pressure sensitive adhesive of the second pressure sensitive adhesive layer is preferably higher than the gel fraction of a pressure sensitive adhesive of the first pressure sensitive adhesive layer. A gel fraction difference between the pressure sensitive adhesive of the first pressure sensitive adhesive layer and the pressure sensitive adhesive of the second pressure sensitive adhesive layer is preferably 15% by weight or more. The gel fraction of the pressure sensitive adhesive of the first pressure sensitive adhesive layer is preferably 55% by weight or less. The gel fraction of the pressure sensitive adhesive of the second pressure sensitive adhesive layer is preferably 75% by weight or more.

Preferably, the pressure sensitive adhesive of the first pressure sensitive adhesive layer is formed of a pressure sensitive adhesive composition containing an acrylic base polymer. Preferably, the acrylic base polymer of the first pressure sensitive adhesive layer contains a hydroxy group-containing monomer and/or a nitrogen-containing monomer as a monomer unit. When the base polymer of the first pressure sensitive adhesive layer contains a hydroxy group-containing monomer, cloudiness of the pressure sensitive adhesive layer is suppressed even when the optical film is exposed to a high-temperature and high-humidity environment.

Preferably, the pressure sensitive adhesive of the second pressure sensitive adhesive layer is formed of a pressure sensitive adhesive composition containing an acrylic base polymer. Preferably, the acrylic base polymer of the second pressure sensitive adhesive layer contains a nitrogen-containing monomer and/or a carboxy group-containing monomer as a monomer unit. When the base polymer of the second pressure sensitive adhesive layer contains a nitrogen-containing monomer and/or a carboxy group-containing monomer, adhesiveness to the front transparent plate or touch panel tends to be improved.

Preferably, the first pressure sensitive adhesive layer and the second pressure sensitive adhesive layer each contain silane coupling agent. When both the first pressure sensitive adhesive layer and the second pressure sensitive adhesive layer contain silane coupling agent, delamination of the laminated pressure sensitive adhesive sheet tends to be suppressed.

The thickness of the first pressure sensitive adhesive layer is preferably 40 μm or more. The thickness of the second pressure sensitive adhesive layer is preferably 5 μm to 70 μm. The ratio of the thickness d₁ of the first pressure sensitive adhesive layer to the thickness d₂ of the second pressure sensitive adhesive layer (d₁/d₂) is preferably 2 to 40.

An optical film with pressure sensitive adhesive according to one aspect of the present invention is an optical film with pressure sensitive adhesive on both sides, which further includes a cell-side pressure sensitive adhesive sheet on the other surface of an optical film.

The laminated pressure sensitive adhesive sheet and the optical film with pressure sensitive adhesive according to the present invention is used for formation of an image display device. The image display device according to the present invention includes the optical film with pressure sensitive adhesive, and a front transparent member on a surface of an image display cell. The optical film and the front transparent member are bonded together with the laminated pressure sensitive adhesive sheet interposed therebetween.

### BRIEF DESCRIPTION OF THE DRAWINGS

FIG. 1 is a sectional view showing one embodiment of a laminated pressure sensitive adhesive sheet;

FIG. 2 is a sectional view showing one embodiment of an optical film with pressure sensitive adhesive;

FIG. 3 is a sectional view showing one embodiment of an optical film with pressure sensitive adhesive on both sides; and

FIG. 4 is a sectional view showing one embodiment of an image display device.

### DESCRIPTION OF EMBODIMENTS

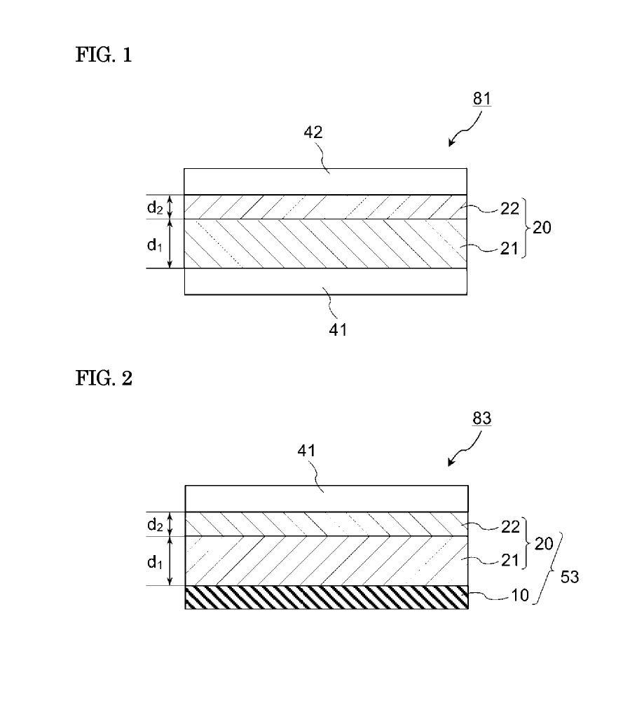

FIG. 1 is a sectional view showing one embodiment of a laminated pressure sensitive adhesive sheet. Pressure sensitive adhesive sheet 20 is a laminate of a first pressure sensitive adhesive layer 21 and a second pressure sensitive adhesive layer 22. The laminated pressure sensitive adhesive sheet 20 is a substrate-less double-sided pressure sensitive adhesive sheet which does not have a substrate such as a film between pressure sensitive adhesive layers. In the embodiment shown in FIG. 1, protective sheets 41 and 42 are temporarily attached on surfaces of the laminated pressure sensitive adhesive sheet on the first pressure sensitive adhesive layer 21 side and the second pressure sensitive adhesive layer 22 side, respectively. FIG. 2 is a schematic sectional view showing one embodiment of an optical film with pressure sensitive adhesive 83 in which the laminated pressure sensitive adhesive sheet 20 is provided on the first main surface of an optical film 10 including a polarizing plate. In the optical film with pressure sensitive adhesive 83, the optical film 10 is bonded to the laminated pressure sensitive adhesive sheet 20 on the first pressure sensitive adhesive layer 21 side.

The laminated pressure sensitive adhesive sheet 20 is a front-side pressure sensitive adhesive sheet, and is used for bonding the front transparent member to the viewing-side of the polarizing plate in formation of an image display device. FIG. 4 is a schematic sectional view showing one embodiment of an image display device including the laminated pressure sensitive adhesive sheet 20 as the front-side pressure sensitive adhesive sheet. In the image display device 100, an optical film 10 is disposed between a front transparent member 70 and an image display cell 61. The front transparent member 70 includes a printed portion 76 formed on a transparent plate 71. The optical film 10 and the image display cell 61 are bonded together with a cell-side pressure sensitive adhesive sheet 26 interposed therebetween, and the optical film 10 and the front transparent member 70 are bonded together with the laminated pressure sensitive adhesive sheet 20 interposed therebetween. The first pressure sensitive adhesive layer 21 is bonded to the optical film 10, and the second pressure sensitive adhesive layer 22 is bonded to the front transparent member 70.

[Front-Side Pressure Sensitive Adhesive Sheet]

As described above, the laminated pressure sensitive adhesive sheet 20 is a front-side pressure sensitive adhesive sheet for bonding the front transparent member to the viewing-side of the polarizing plate. The laminated pressure sensitive adhesive sheet 20 includes at least two pressure sensitive adhesive layers. The first pressure sensitive adhesive layer 21 is a pressure sensitive adhesive layer for bonding to the optical film 10, and the second pressure sensitive adhesive layer 22 is a pressure sensitive adhesive layer for bonding to the front transparent member. In an optical film with pressure sensitive adhesive in which the laminated pressure sensitive adhesive sheet 20 is provided on the optical film 10, the first pressure sensitive adhesive layer 21 is disposed in contact with the optical film 10, and the second pressure sensitive adhesive layer 22 is disposed at the furthest from the optical film 10. When the laminated pressure sensitive adhesive sheet is two-layered structure consisting of the first pressure sensitive adhesive layer 21 and the second pressure sensitive adhesive layer 22, an optical film with pressure sensitive adhesive 53 includes the first pressure sensitive adhesive layer 21 and the second pressure sensitive adhesive layer in this order on the optical film 10.

The first pressure sensitive adhesive layer 21 disposed in contact with the optical film 10 is formed of a relatively soft pressure sensitive adhesive, and the second pressure sensitive adhesive layer 22 disposed at the furthest from the optical film 10 is formed of a relatively hard pressure sensitive adhesive. Since the second pressure sensitive adhesive layer 22 provided in contact with the front transparent member is a hard pressure sensitive adhesive, the pressure sensitive adhesive layer can resist the outgas release pressure even when the front transparent member is formed of a material which generates an outgas (e.g. a plastic material such as an acrylic plate or a polycarbonate plate). Therefore, remaining of bubbles between the pressure sensitive adhesive sheet and the front transparent member can be suppressed. Since the first pressure sensitive adhesive layer 21 is a soft pressure sensitive adhesive, the softness (fluidity) of the overall laminated pressure sensitive adhesive sheet 20 is maintained. Therefore, the pressure sensitive adhesive can penetrate to the vicinity of the printing level difference of the front transparent member, so that ingress of bubbles to the vicinity of the level difference can be suppressed. Further, since the softness of the overall laminated pressure sensitive adhesive sheet 20 is maintained, display unevenness on the peripheral edge portion of a screen which is caused due to a printing level difference can be suppressed.

For example, when the gel fraction of the pressure sensitive adhesive of first pressure sensitive adhesive layer 21 is lower than the gel fraction of pressure sensitive adhesive of the second pressure sensitive adhesive layer 22, the first pressure sensitive adhesive layer can be made relatively soft. When the pressure sensitive adhesives of the first pressure sensitive adhesive layer and the second pressure sensitive adhesive layer have different gel fractions, both the layers can be made to have different viscoelastic behaviors, so that ingress of bubbles to the vicinity of the printing level difference and image display unevenness can be suppressed as well as remaining of bubbles at the interface which is caused by an outgas from the front transparent member can be suppressed.

<Characteristics of First Pressure Sensitive Adhesive Layer>

(Storage Elastic Modulus)

The first pressure sensitive adhesive layer 21 provided on the optical film 10 side has a storage elastic modulus G′₁₅₀ of 9×10³ Pa or less at 150° C. When the storage elastic modulus of the first pressure sensitive adhesive layer at a high temperature is low, fluidity in vacuum heating and in heating and bonding by an autoclave is high, so that the pressure sensitive adhesive easily penetrates to the vicinity of the level difference, and therefore generation of bubbles in the vicinity of the level difference can be suppressed. On the other hand, for suppressing protrusion of the pressure sensitive adhesive from the film end surface in the heating state during bonding, the storage elastic modulus G′₁₅₀ of the first pressure sensitive adhesive layer 21 at 150° C. is preferably 3×10² Pa or more. The storage elastic modulus G′₁₅₀ of the first pressure sensitive adhesive layer is more preferably 5×10² Pa to 9×10³ Pa.

Similarly, for ensuring high fluidity during heating, and suppressing protrusion of the pressure sensitive adhesive from the end surface, the storage elastic modulus G′₁₀₀ of the first pressure sensitive adhesive layer 21 at 100° C. is preferably 8×10² Pa to 1.2×10⁴ Pa, more preferably 9×10² Pa to 1×10⁴ Pa, further preferably 1×10³ Pa to 1×10⁴ Pa.

The storage elastic modulus G′₂₀ of the first pressure sensitive adhesive layer 21 at 20° C. is preferably 5×10⁴ Pa to 1×10⁷ Pa, more preferably 8×10⁴ Pa to 5×10⁶ Pa, further preferably 1×10⁵ Pa to 1×10⁶ Pa. When the storage elastic modulus at normal temperature is 5×10⁴ Pa or more, deposition of the pressure sensitive adhesive on a cutting blade etc. can be reduced at the time of cutting the pressure sensitive adhesive sheet and the optical film with pressure sensitive adhesive to a predetermined size. When the storage elastic modulus at normal temperature is 1×10⁷ Pa or less, breakage, chipping and the like of the pressure sensitive adhesive at the cut surface can be prevented at the time of cutting the pressure sensitive adhesive sheet and the optical film with pressure sensitive adhesive to a predetermined size. When the storage elastic modulus G′₂₀ of the first pressure sensitive adhesive layer falls within the above-mentioned range, a cohesive forth required for processability, handling characteristics and the like can be retained, and initial tackiness in bonding to the optical film can be secured.

The first pressure sensitive adhesive layer 21 has a ratio G′₂₀/G′₁₅₀ of 20 or more, where G′₂₀ is a storage elastic modulus at 20° C. and G′₁₅₀ is a storage elastic modulus at 150° C. The temperature dependency of the storage elastic modulus is high, and thus at normal temperature, fluidity is small, so that transfer of the pressure sensitive adhesive to a cutting blade etc. during cutting can be suppressed. During heating, fluidity is high, so that the pressure sensitive adhesive easily penetrates to the vicinity of the printing level difference, and therefore ingress of bubbles to the vicinity of the printing level difference and display unevenness in the image display device can be suppressed. The ratio G′₂₀/G′₁₅₀ is preferably 25 or more, more preferably 30 or more. The upper limit of the ratio G′₂₀/G′₁₅₀ is not particularly limited, but it is preferably 500 or less, more preferably 300 or less, further preferably 100 or less in view of tackiness during bonding at normal temperature, fluidity during heating, and so on.

From the same viewpoint, the ratio G′₂₀/G′₁₀₀ of the first pressure sensitive adhesive layer 21 is preferably 15 or more, more preferably 18 to 300, further preferably 20 to 100, where G′₂₀ is a storage elastic modulus at 20° C. and G′₁₀₀ is a storage elastic modulus at 100° C.

In this specification, the storage elastic modulus G′ is determined by reading a value at a predetermined temperature in measurement performed at a temperature elevation rate of 5° C./minute in a range of −50 to 150° C. under the condition of a frequency of 1 Hz in accordance with the method described in JIS K 7244-1 “Plastics—Determination of Dynamic Mechanical Properties”. The elastic modulus of a material exhibiting viscoelasticity, such as a pressure sensitive adhesive, can be represented by a storage elastic modulus G′ and a loss elastic modulus G″. In general, the loss elastic modulus G″ is an index indicating a degree of viscosity, while the storage elastic modulus G′ is used as an index indicating a degree of hardness.

(Residual Stress)

The residual stress of the first pressure sensitive adhesive layer at 20° C. is preferably 0.1 to 6 N/cm², more preferably 0.2 to 5 N/cm², further preferably 0.3 to 4 N/cm². When the residual stress falls within the above-mentioned range, level difference followability can be imparted to the pressure sensitive adhesive to suppress bubbles and display unevenness, and suppress protrusion of the pressure sensitive adhesive from the end surface and transfer of the pressure sensitive adhesive to a cutting blade etc. during cutting.

The residual stress in this specification is measured by a tensile stress relaxation test under the conditions of a temperature of 25° C., a strain of 300% and a relaxation time of 180 seconds. Specifically, the residual stress is a stress (tensile stress) after elapse of 180 seconds after the pressure sensitive adhesive is deformed at a tension speed of 200 mm/minute by a tension tester until the strain reaches 300% (4 times as large as the original length). The residual stress correlates with the storage elastic modulus, and the residual stress tends to increase as the storage elastic modulus becomes larger. When the composition of the base polymer in the pressure sensitive adhesive is unchanged, the residual stress tends to linearly increase as the gel fraction (crosslinking degree) increases.

(Gel Fraction)

The optimum value of the gel fraction (ratio of solvent-insoluble components) of the pressure sensitive adhesive varies depending on the composition etc. of the pressure sensitive adhesive. The gel fraction of the first pressure sensitive adhesive layer 21 is preferably 55% or less, more preferably 52% or less, further preferably 50% or less for imparting level difference absorbency. The lower limit of the gel fraction of the first pressure sensitive adhesive layer 21 is not particularly limited, but it is preferably 15% or more, more preferably 20% or more, further preferably 25% or more for suppressing protrusion of the pressure sensitive adhesive from the end surface, and transfer of the pressure sensitive adhesive to a cutting blade etc. during cutting.

The gel fraction of the pressure sensitive adhesive can be determined as a content of components insoluble in a solvent, and specifically, it is determined as a weight fraction (unit: % by weight) of insoluble components after immersion of the pressure sensitive adhesive (pressure sensitive adhesive layer or pressure sensitive adhesive sheet) in a solvent at 23° C. for 7 days to the sample before immersion. When the pressure sensitive adhesive is an acryl-based pressure sensitive adhesive, ethyl acetate is used as a solvent. Generally, the gel fraction of a polymer is equal to the crosslinking degree, and as the amount of the crosslinked portion in the polymer increases, the gel fraction becomes higher, so that the storage elastic modulus G′ and residual stress tend to increase.

(Thickness)

The thickness d₁ of the first pressure sensitive adhesive layer 21 is preferably 40 μm or more. The thickness d₁ of the first pressure sensitive adhesive layer is more preferably 50 μm or more, further preferably 60 μm or more, especially preferably 70 μm or more, most preferably 80 μm or more. By increasing the thickness of the first pressure sensitive adhesive layer, the fluidity of the laminated pressure sensitive adhesive sheet during heating is improved, and ingress of bubbles to the vicinity of the printing level difference can be suppressed. By increasing the thickness of the first pressure sensitive adhesive layer, the level difference absorbency of the pressure sensitive adhesive sheet is improved, and therefore display unevenness in the image display device can be suppressed.

The upper limit of the thickness d₁ of the first pressure sensitive adhesive layer 21 is not particularly limited, but it is preferably 500 μm or less, more preferably 400 μm or less, further preferably 300 μm or less, especially preferably 250 μm or less from the viewpoint of productivity of the pressure sensitive adhesive sheet, prevention of protrusion from the end surface, and so on.

<Properties of Second Pressure Sensitive Adhesive Layer>

(Storage Elastic Modulus)

The second pressure sensitive adhesive layer 22 disposed at the furthest from the optical film 10 is used for bonding the front transparent member. The storage elastic modulus of the second pressure sensitive adhesive layer 22 at 150° C. is 1×10⁴ Pa or more. The second pressure sensitive adhesive layer shows high storage elastic modulus at a high temperature, and thus the second pressure sensitive adhesive layer can resist the outgas release pressure even if outgas is released from the front transparent member. Therefore, remaining of bubbles at the interface between the pressure sensitive adhesive sheet and the front transparent member can be suppressed. On the other hand, if the second pressure sensitive adhesive layer shows excessively high storage elastic modulus at a high temperature, penetration of the pressure sensitive adhesive to the vicinity of the printing level difference may be hindered to generate bubbles, or display unevenness may occur in the image display device even when the storage elastic modulus of the first pressure sensitive adhesive layer is low. Therefore, the storage elastic modulus G′₁₅₀ of the second pressure sensitive adhesive layer 22 at 150° C. is preferably 1×10⁶ Pa or less. The storage elastic modulus G′₁₅₀ of the second pressure sensitive adhesive layer is more preferably 1×10⁴ Pa to 8×10⁵ Pa, further preferably 3×10⁴ Pa to 5×10⁵ Pa.

Similarly, for suppressing remaining of outgas at the interface during heating, and suppressing bubbles and display unevenness in the vicinity of the printing level difference, the storage elastic modulus G′₁₀₀ of the second pressure sensitive adhesive layer 22 at 100° C. is preferably 1×10⁴ Pa to 1×10⁶ Pa, more preferably 3×10⁴ Pa to 9×10⁵ Pa, further preferably 4×10⁴ Pa to 6×10⁵ Pa.

If the storage elastic modulus G′₂₀ of the second pressure sensitive adhesive layer is excessively high, ingress of bubbles to the vicinity of the level difference tends to easily occur at the initial stage of bonding. If the storage elastic modulus G′₂₀ of the second pressure sensitive adhesive layer is excessively high, stress resulting from the level difference of the front transparent member cannot be absorbed by the second pressure sensitive adhesive layer and thus display unevenness easily occurs. Therefore, the storage elastic modulus G′₂₀ of the second pressure sensitive adhesive layer 22 at 20° C. is preferably 1×10⁶ Pa or less, more preferably 8×10⁵ Pa or less, further preferably 6×10⁵ Pa or less.

For reducing deposition of the pressure sensitive adhesive on a cutting blade etc. at the time when the pressure sensitive adhesive sheet or the optical film with pressure sensitive adhesive is cut to a predetermined size, the storage elastic modulus G′₂₀ of the second pressure sensitive adhesive layer is preferably 5×10⁴ Pa or more, more preferably 8×10⁴ Pa or more, further preferably 1×10⁵ Pa or more.

The ratio G′₂₀/G′₁₅₀ of the second pressure sensitive adhesive layer 22 is preferably 20 or less, more preferably 15 or less, further preferably 10 or less. When the value of G′₂₀/G′₁₅₀ is small, temperature dependency of the storage elastic modulus is low, and thus the fluidity of the pressure sensitive adhesive is low either at normal temperature or during heating. Therefore, transfer of the pressure sensitive adhesive to a cutting blade etc. during cutting at normal temperature can be suppressed, and remaining of bubbles at the bonding interface can be suppressed even if outgas is generated from the front transparent member during heating. The lower limit of the ratio G′₂₀/G′₁₅₀ is not particularly limited, but it is generally more than 1, preferably 2 or more. When the gel fraction of the second pressure sensitive adhesive layer is increased, the ratio G′₂₀/G′₁₅₀ tends to be reduced.

From the same viewpoint, the ratio G′₂₀/G′₁₀₀ of the storage elastic modulus G′₂₀ at 20° C. to the storage elastic modulus G′₁₀₀ at 100° C. in the second pressure sensitive adhesive layer 22 is preferably 15 or less, more preferably 10 or less, further preferably 8 or less.

The storage elastic modulus G′₁₅₀ of the second pressure sensitive adhesive layer 22 is preferably larger than the storage elastic modulus G′₁₅₀ of the first pressure sensitive adhesive layer 21. The storage elastic modulus G′₁₅₀ of the second pressure sensitive adhesive layer is preferably 3 times or more, more preferably 5 times or more, further preferably 7 times or more, especially preferably 10 times or more the storage elastic modulus G′₁₅₀ of the first pressure sensitive adhesive layer. Similarly, the storage elastic modulus G′₁₀₀ of the second pressure sensitive adhesive layer is preferably 2 times or more, more preferably 3 times or more, further preferably 5 times or more, especially preferably 8 times or more the storage elastic modulus G′₁₀₀ of the first pressure sensitive adhesive layer.

The ratio G′₂₀/G′₁₅₀ of the first pressure sensitive adhesive layer 21 is preferably larger than the ratio G′₂₀/G′₁₅₀ of the second pressure sensitive adhesive layer 22. The ratio G′₂₀/G′₁₅₀ of the first pressure sensitive adhesive layer 21 is preferably 3 times or more, more preferably 5 times or more, further preferably 7 times or more, especially preferably 10 times or more the ratio G′₂₀/G′₁₅₀ of the second pressure sensitive adhesive layer 22. The ratio G′₂₀/G′₁₀₀ of the first pressure sensitive adhesive layer 21 is preferably larger than the ratio G′₂₀/G′₁₀₀ of the second pressure sensitive adhesive layer 22. The ratio G′₂₀/G′₁₀₀ of the first pressure sensitive adhesive layer 21 is preferably 2 times or more, more preferably 4 times or more, further preferably 6 times or more, especially preferably 8 times or more the ratio G′₂₀/G′₁₀₀ of the second pressure sensitive adhesive layer 22. The ratio G′₂₀/G′₁₅₀ and the ratio G′₂₀/G′₁₀₀ of the first pressure sensitive adhesive layer and the second pressure sensitive adhesive layer are indices showing a difference in temperature dependency of the storage elastic modulus between these pressure sensitive adhesive layers, and the larger the ratio is, the greater the difference in viscoelastic behavior is.

In the laminated pressure sensitive adhesive sheet according to the present invention, a plurality of pressure sensitive adhesive layers which are different in temperature dependency of the storage elastic modulus and have a great difference in storage elastic modulus in a high-temperature state are laminated, so that the fluidity of the overall pressure sensitive adhesive sheet can be improved to impart printing level difference absorbency thereto, and also remaining of outgas at the bonding interface can be suppressed.

(Residual Stress)

The residual stress of the second pressure sensitive adhesive layer at 25° C. is preferably 1 to 30 N/cm², more preferably 3 to 20 N/cm², further preferably 5 to 15 N/cm². The residual stress of the second pressure sensitive adhesive layer is preferably larger than the residual stress of the first pressure sensitive adhesive layer. When the residual stress of the second pressure sensitive adhesive layer is large, remaining of outgas at the bonding interface can be suppressed.

The residual stress of the second pressure sensitive adhesive layer is preferably larger than the residual stress of the first pressure sensitive adhesive layer. A layer having larger residual stress while having the same storage elastic modulus has a harder pressure sensitive adhesive, and thus tends to exhibit a stronger resistance to an external force. Therefore, by increasing the residual stress of the second pressure sensitive adhesive layer, the effect of suppressing remaining of outgas generated from the front transparent member can be improved. The residual stress of the second pressure sensitive adhesive layer is preferably 1.5 times or more, more preferably 2 times or more, further preferably 2.5 times or more the residual stress of the first pressure sensitive adhesive layer.

(Gel Fraction)

The gel fraction of the pressure sensitive adhesive of the second pressure sensitive adhesive layer 22 is preferably higher than the gel fraction of the pressure sensitive adhesive of the first pressure sensitive adhesive layer. The gel fraction of the pressure sensitive adhesive of the second pressure sensitive adhesive layer is higher than the gel fraction of the pressure sensitive adhesive of the first pressure sensitive adhesive layer preferably by 15% or more, more preferably by 20% or more, further preferably by 25% or more, especially preferably by 30% or more. The gel fraction of the pressure sensitive adhesive of the second pressure sensitive adhesive layer is preferably 75% or more, more preferably 80% or more, further preferably 85% or more. The gel fraction of the pressure sensitive adhesive of the second pressure sensitive adhesive layer is preferably 99% or less, more preferably 95% or less.

When the gel fraction in the second pressure sensitive adhesive layer is made relatively large, remaining of outgas at the bonding interface can be suppressed. When the gel fraction in the second pressure sensitive adhesive layer is 75% or more, peeling of the pressure sensitive adhesive from the front transparent member under a high-temperature environment is suppressed. When the gel fraction is 99% or less, moderate cohesiveness and flexibility are obtained, so that initial adhesiveness is improved.

(Thickness)

The thickness d₂ of the second pressure sensitive adhesive layer 22 is preferably 5 μm or more, more preferably 10 μm or more, further preferably 15 μm or more. In an image display device, the second pressure sensitive adhesive layer is in contact with the front transparent member. When the thickness of the second pressure sensitive adhesive layer is increased, the outgas release pressure resistance is imparted. Therefore, remaining of bubbles at the interface between the pressure sensitive adhesive sheet and the front transparent member can be suppressed even if outgas is released from the front transparent member.

The thickness of the second pressure sensitive adhesive layer is preferably 70 μm or less, more preferably 50 μm or less, further preferably 40 μm or less. The thickness d₂ of the second pressure sensitive adhesive layer 22 is preferably smaller than the thickness d₁ of the first pressure sensitive adhesive layer 21. The ratio d₁/d₂ of the thickness d₁ of the first pressure sensitive adhesive layer 21 to the thickness d₂ of the second pressure sensitive adhesive layer 22 is preferably 2 to 50, more preferably 3 to 30, further preferably 4 to 20.

When the thickness of the first pressure sensitive adhesive layer is made relatively large as compared to the second pressure sensitive adhesive layer, the viscoelastic behavior of the overall laminated pressure sensitive adhesive sheet 20 including the first pressure sensitive adhesive layer 21 and the second pressure sensitive adhesive layer 22 laminated on each other is dominated by the viscoelasticity of the first pressure sensitive adhesive layer. Therefore, the level difference absorbency of the laminated pressure sensitive adhesive sheet is improved, so that ingress of bubbles to the vicinity of the printing level difference and display unevenness in the image display device can be suppressed. On the other hand, suppression of release of outgas from the front transparent member is dominated by the characteristics of the second pressure sensitive adhesive layer that is in contact with the front transparent member. In the laminated pressure sensitive adhesive sheet according to the present invention, a hard pressure sensitive adhesive is used as the second pressure sensitive adhesive layer, and thus even when the front transparent member is formed of a material that generates outgas, the outgas release pressure can be resisted. Therefore, remaining of bubbles between the pressure sensitive adhesive sheet and the front transparent member can be suppressed.

<Characteristics of Laminated Pressure Sensitive Adhesive Sheet>

In the laminated pressure sensitive adhesive sheet 20, the first pressure sensitive adhesive layer 21 is disposed on a surface bonded to the optical film, and the second pressure sensitive adhesive layer 22 is disposed on a surface bonded to the front transparent member. The laminated pressure sensitive adhesive sheet may be a laminate of these two layers, or may have another pressure sensitive adhesive layer between the first pressure sensitive adhesive layer and the second pressure sensitive adhesive layer.

(Storage Elastic Modulus)

The storage elastic modulus G′₁₅₀ of the laminated pressure sensitive adhesive sheet at 150° C. is preferably 2×10⁴ Pa or less, more preferably 1×10⁴ Pa or less, further preferably 9×10³ Pa or less. When the storage elastic modulus G′₁₅₀ of the laminated pressure sensitive adhesive sheet falls within the above-mentioned range, generation of bubbles in the vicinity of the level difference and occurrence of display unevenness in the image display device can be suppressed. For suppressing protrusion of the pressure sensitive adhesive from the film end surface, the storage elastic modulus G′₁₅₀ of the laminated pressure sensitive adhesive sheet at 150° C. is preferably 5×10² Pa or more, more preferably 8×10² Pa or more.

Similarly, for ensuring high fluidity during heating, and suppressing protrusion of the pressure sensitive adhesive from the end surface, the storage elastic modulus G′₁₀₀ of the laminated pressure sensitive adhesive sheet 20 at 100° C. is preferably 5×10² to 3×10⁴ Pa, more preferably 8×10² to 2×10⁴ Pa, further preferably 1×10³ to 1.5×10⁴ Pa.

The storage elastic modulus G′₂₀ of the laminated pressure sensitive adhesive sheet 20 at 20° C. is preferably 5×10⁴ Pa to 1×10⁷ Pa, more preferably 8×10⁴ Pa to 5×10⁶ Pa, further preferably 1×10⁵ Pa to 1×10⁶ Pa. When G′₂₀ falls within the above-mentioned range, deposition of the pressure sensitive adhesive on a cutting blade etc. and breakage and chipping of the pressure sensitive adhesive can be suppressed at the time when the pressure sensitive adhesive sheet or the optical film with pressure sensitive adhesive is cut to a predetermined size.

The ratio G′₂₀/G′₁₅₀ of the laminated pressure sensitive adhesive sheet 20 is preferably 20 or more, more preferably 25 or more, further preferably 30 or more, where G′₂₀ is a storage elastic modulus at 20° C. and G′₁₅₀ is a storage elastic modulus at 150° C. When the temperature dependency of the storage elastic modulus of the laminated pressure sensitive adhesive sheet is high, and thus fluidity is small thus at normal temperature, transfer of the pressure sensitive adhesive to a cutting blade etc. during cutting can be suppressed. During heating, fluidity is high, so that the pressure sensitive adhesive easily penetrates to the vicinity of the printing level difference, and therefore ingress of bubbles to the vicinity of the printing level difference and display unevenness in the image display device can be suppressed. The upper limit of the ratio G′₂₀/G′₁₅₀ is not particularly limited, but it is preferably 500 or less, more preferably 300 or less, further preferably 100 or less in view of tackiness during bonding at normal temperature, fluidity during heating, and so on.

From the same viewpoint, the ratio of the storage elastic modulus G′₂₀ at 20° C. to the storage elastic modulus G′₁₀₀ at 100° C. (G′₂₀/G′₁₀₀) in the laminated pressure sensitive adhesive sheet 20 is preferably 10 or more, more preferably 15 to 300, further preferably 20 to 100.

As described above, when the thickness of the first pressure sensitive adhesive layer 21 is made relatively large as compared to the second pressure sensitive adhesive layer 22, the viscoelastic behavior of the overall laminated pressure sensitive adhesive sheet 20 is dominated by the viscoelasticity of the first pressure sensitive adhesive layer. Therefore the values of G′₂₀/G′₁₅₀ and G′₂₀/G′₁₀₀ can be adjusted to fall within the above-mentioned respective ranges by increasing the temperature dependency of the storage elastic modulus of the laminated pressure sensitive adhesive sheet.

(Thickness)

For improving the level difference absorbency of the laminated pressure sensitive adhesive sheet to suppress display unevenness in the image display device, the thickness of the laminated pressure sensitive adhesive sheet 20 is preferably 55 μm or more, more preferably 100 μm or more, further preferably 130 μm or more, especially preferably 150 μm or more. On the other hand, the thickness of the laminated pressure sensitive adhesive sheet is preferably 550 μm or less, more preferably 450 μm or less, further preferably 350 μm or less, especially preferably 300 μm or less from the viewpoint of productivity of the pressure sensitive adhesive sheet, prevention of protrusion from the end surface, and so on.

As described above, the laminated pressure sensitive adhesive sheet may have another pressure sensitive adhesive layer between the first pressure sensitive adhesive layer and the second pressure sensitive adhesive layer. Although the composition and characteristics of the pressure sensitive adhesive layer disposed between the first pressure sensitive adhesive layer and the second pressure sensitive adhesive layer are not particularly limited, it is preferable that the characteristics of the overall laminated pressure sensitive adhesive sheet satisfy the above-mentioned requirements. The laminated pressure sensitive adhesive sheet preferably has a two-layer laminated structure consisting of the first pressure sensitive adhesive layer and the second pressure sensitive adhesive layer, from the viewpoint of productivity of the laminated pressure sensitive adhesive sheet and ease of controlling the characteristics thereof.

<Compositions of Pressure Sensitive Adhesive>

Compositions of the pressure sensitive adhesives for forming the first pressure sensitive adhesive layer 21 and the second pressure sensitive adhesive layer 22, respectively, are not particularly limited as long as the pressure sensitive adhesives satisfy the above mentioned requirements. Pressure sensitive adhesives containing a base polymer such as an acryl-based polymer, a silicone-based polymer, a polyester, a polyurethane, a polyamide, a polyvinyl ether, a vinyl acetate/vinyl chloride copolymer, a modified polyolefin, an epoxy-based polymer, a fluorine-based polymer, or a polymer based on a rubber such as a natural rubber or a synthetic rubber can be appropriately selected. Since the first pressure sensitive adhesive layer and the second pressure sensitive adhesive layer are used in an image display device, pressure sensitive adhesives excellent in optical transparency are preferably used. Specifically, it is preferred that the first pressure sensitive adhesive layer and the second pressure sensitive adhesive layer each have a haze of 1.0% or less, and a total light transmittance of 90% or more.

As a pressure sensitive adhesive excellent in optical transparency and adhesiveness, an acryl-based pressure sensitive adhesive containing an acryl-based polymer as a base polymer is preferably used. In the acryl-based pressure sensitive adhesive, the content of the acrylic base polymer based on the total amount of solid components in the pressure sensitive adhesive composition is preferably 50% by weight or more, more preferably 70% by weight or more, further preferably 80% by weight or more.

As the acryl-based polymer, one having a monomer unit of a (meth)acrylic acid alkyl ester as a main skeleton is suitably used. In this specification, the “(math)acryl” means acryl and/or methacryl.

As the (meth)acrylic acid alkyl ester, a (meth)acrylic acid alkyl ester with the alkyl group having 1 to 20 carbon atoms is preferably used. Examples of the (meth)acrylic acid alkyl ester include methyl (meth)acrylate, ethyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, neopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, isotridodecyl (meth)acrylate, tetradecyl (meth)acrylate, isotetradecyl (meth)acrylate, pentadecyl (meth)acrylate, cetyl (meth)acrylate, heptadecyl (meth)acrylate, octadecyl (meth)acrylate, isooctadecyl (meth)acrylate, nonadecyl (meth)acrylate, isostearyl (meth)acrylate and alakyl (meth)acrylate.

The content of the (meth)acrylic acid alkyl ester is preferably 40% by weight or more, more preferably 50% by weight or more, further preferably 60% by weight or more based on the total amount of monomer components that form the base polymer.

For satisfying the above-mentioned characteristics, a copolymer of a plurality of (meth)acrylic acid alkyl esters is preferably used as an acrylic base polymer of each of the first pressure sensitive adhesive layer and the second pressure sensitive adhesive layer. In the copolymer, the arrangement of constituent monomer units may be random, or blockwise.

The alkyl group of the (meth)acrylic acid alkyl ester may have a branch. As the branched alkyl (meth)acrylic acid ester, 2-ethylhexyl (meth)acrylate, isooctyl (meth)acrylate, isononyl (meth)acrylate, isodecyl (meth)acrylate, isotetradecyl (meth)acrylate, isooctadecyl (meth)acrylate or the like is suitably used. Two or more branched alkyl (meth)acrylic acid esters may be used in combination.

The acrylic base polymer preferably contains an acryl-based monomer unit having a crosslinkable functional group as a copolymer component. When the base polymer has a crosslinkable functional group, the gel fraction of the pressure sensitive adhesive can be easily increased by thermal crosslinking, photocuring or the like of the base polymer. Examples of the acryl-based monomer having a crosslinkable functional group include hydroxy group-containing monomers and carboxy group-containing monomers.

Particularly, when the base polymer contains a hydroxy group-containing monomer or a nitrogen-containing monomer as a copolymerizable component, cloudiness of the pressure sensitive adhesive under a high-temperature and high-humidity environment tends to be suppressed, so that a pressure sensitive adhesive having high transparency can be obtained. The laminated pressure sensitive adhesive sheet 20 is preferably one in which at least one of the first pressure sensitive adhesive layer 21 and the second pressure sensitive adhesive layer 22 contains at least one of a hydroxy group-containing monomer and a nitrogen-containing monomer as a copolymerizable component of the base polymer. Particularly, for suppressing cloudiness of the laminated pressure sensitive adhesive sheet under a high-temperature and high-humidity environment, it is preferable that the relatively thick first pressure sensitive adhesive layer contains at least one of a hydroxy group-containing monomer and a nitrogen-containing monomer as a copolymerizable component of the base polymer, and it is more preferable that both the first pressure sensitive adhesive layer and the second pressure sensitive adhesive layer contain at least one of a hydroxy group-containing monomer and a nitrogen-containing monomer as a copolymerizable component of the base polymer. The total content of the hydroxy group-containing monomer and the nitrogen-containing monomer is preferably 5 to 50% by weight, more preferably 7 to 45% by weight, further preferably 10 to 40% by weight based on the total amount of constituent monomer units of the base polymer.

Examples of the hydroxy group-containing monomer include 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate and (4-hydroxymethylcydohexyl)-methyl acrylate.

Examples of the nitrogen-containing monomer include vinyl-based monomer such as N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, (meth)acryloylmorpholine, N-vinylcarboxylic acid amides and N-vinylcaprolactam; and cyanoacrylate-based polymer such as acrylonitrile and methacrylonitrile. Among them, N-vinylpyrrolidone and (meth)acryloylmorpholine are preferably used.

When the base polymer contains a carboxy group-containing monomer or a nitrogen-containing monomer as a copolymerizable component, the cohesive force of the pressure sensitive adhesive is improved, so that adhesiveness of the pressure sensitive adhesive sheet to an adherend tends to be improved even when the gel fraction is high. Therefore, it is preferable that the second pressure sensitive adhesive layer 22 contains at least one of a carboxy group-containing monomer and a nitrogen-containing monomer as a copolymerizable component of the base polymer. The content of the carboxy group-containing monomer unit is preferably 2 to 20% by weight, more preferably 3 to 15% by weight based on the total amount of constituent monomer units of the base polymer. The content of the nitrogen-containing monomer unit is preferably 3 to 40% by weight, more preferably 5 to 30% by weight, further preferably 7 to 25% by weight based on the total amount of constituent monomer units of the base polymer.

Examples of the carboxy group-containing monomer include (meth)acrylic acid, carboxyethyl (meth)acrylate, carboxypentyl (meth)acrylate, itaconic acid, maleic acid, fumaric acid and crotonic acid. Among them, acrylic acid is preferably used.

Besides the above-mentioned components, an acid anhydride group-containing monomer, a caprolactone adduct of acrylic acid, a sulfonic acid group-containing monomer, a phosphoric acid group-containing monomer or the like may be used as a copolymerizable monomer component of the base polymer.

Monomer components that form the acryl-based polymer may include a polyfunctional monomer component. When a polyfunctional monomer is contained as a copolymerizable monomer component, the gel fraction of the pressure sensitive adhesive tends to be increased. The polyfunctional monomer is a monomer having at least two polymerizable functional groups each having an unsaturated double bond, such as (meth)acryloyl groups.

By using a polyfunctional monomer, a branching point is introduced into the base polymer, so that the gel fraction of the pressure sensitive adhesive tends to be increased. The gel fraction of the pressure sensitive adhesive tends to increase with an increase in the amount of the polyfunctional monomer used. Although suitable amount of the polyfunctional monomer varies depending on the molecular weight thereof, the number of functional groups, or the like, it is preferably 3% by weight or less, more preferably 2% by weight or less, further preferably 1% by weight or less based on the total amount of monomer components that form the (meth)acryl-based polymer. When the amount of the polyfunctional monomer is more than 3% by weight, the storage elastic modulus of the pressure sensitive adhesive excessively increases, so that bubbles and display unevenness are easily generated in the vicinity of the level difference portion of the front transparent member.

The acrylic base polymer can be prepared by known methods such as solution polymerization, UV polymerization, mass polymerization and emulsification polymerization. Solution polymerization methods or active energy ray polymerization (e.g., UV polymerization) is preferable from the viewpoint of transparency, water resistance, costs and so on. As a solvent for solution polymerization, ethyl acetate, toluene or the like is generally used.

In preparation of the acryl-based polymer, a polymerization initiator such as a photopolymerization initiator or a thermopolymerization initiator may be used depending on a type of polymerization reaction. The photopolymerization initiator is not particularly limited as long as it initiates photopolymerization, and for example, a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzyl-based photopolymerization initiator, a benzophenone-based photopolymerization initiator, a ketal-based photopolymerization initiator, a thioxanthone-based photopolymerization initiator, an acyl phosphine oxide-based photopolymerization initiator or the like can be used. As the thermopolymerization initiator, for example, an azo-based initiator, a peroxide-based initiator, a redox-based initiator obtained by combining a peroxide and a reducing agent (e.g., combination of a persulfate and sodium hydrogen sulfite, combination of a peroxide and sodium ascorbate, or the like) can be used.

For adjusting the molecular weight of the base polymer, a chain-transfer agent may be used. The chain-transfer agent can receive radicals from a growing polymer chain to stop extension of the polymer, and the chain-transfer agent having received the radicals can attack the monomer to start polymerization again. Accordingly, when a chain-transfer agent is used, an increase in molecular weight of the base polymer is inhibited without reducing the concentration of radicals in the reaction system, so that a pressure sensitive adhesive sheet having small residual stress can be obtained. As the chain-transfer agent, for example, a thiol such as α-thioglycerol, lauryl mercaptan, glycidyl mercaptan, mercaptoacetic acid, 2-mercaptoethanol, thioglycolic acid, 2-ethylhexyl thioglycollate or 2,3-dimercapto-1-propanol is suitably used.

When a polyfunctional monomer, in addition to a monofunctional monomer, is used as a monomer component that forms the acryl-based polymer, the monofunctional monomer may be first polymerized to form a prepolymer composition with a low polymerization degree (preliminary polymerization), followed by polymerizing the prepolymer with the polyfunctional monomer by adding the polyfunctional monomer to a syrup of the prepolymer composition (post-polymerization). By performing preliminary polymerization followed by post-polymerization of the prepolymer as described above, a branching point derived from a polyfunctional monomer component can be uniformly introduced into a base polymer. A mixture of a prepolymer composition and a non-polymerized monomer component (pressure sensitive adhesive composition) may be applied onto a base material, and then subjected to post-polymerization on the base material to form a pressure sensitive adhesive sheet. The prepolymer composition has a low viscosity and is thus excellent in coatability, and therefore by using a method in which a pressure sensitive adhesive composition as a mixture of a prepolymer composition and a non-polymerized monomer is applied, and then subjected post-polymerization on a base material, the productivity of a pressure sensitive adhesive sheet is improved, and the thickness of the pressure sensitive adhesive sheet can be made uniform.

The prepolymer composition can be prepared by, for example, partially polymerizing (preliminarily polymerizing) a composition (referred to as a “prepolymer forming composition”) obtained by mixing a monomer component that forms an acrylic base polymer, and a polymerization initiator. Among the aforementioned monomer components that form the acryl-based polymer, the monomer component in the prepolymer forming composition is preferably a monofunctional monomer component such as a (meth)acrylic acid alkyl ester or a polar group-containing monomer. The monomer component for forming the prepolymer may contain not only a monofunctional monomer but also a polyfunctional monomer. For example, after a part of a polyfunctional monomer component as a raw material of a base polymer is included in a prepolymer forming composition, and a prepolymer is polymerized, the remaining part of the polyfunctional monomer component may be added and subjected to post-polymerization.

In addition to the monomer component and a polymerization initiator, the prepolymer forming composition may contain a chain-transfer agent etc. as necessary. The method for polymerizing a prepolymer forming composition is not particularly limited, but polymerization by irradiation of an active ray such as UV light is preferable for adjusting the reaction time to ensure that the molecular weight (polymerization ratio) of the prepolymer falls within a desired range. The polymerization initiator and the chain-transfer agent to be used for preliminary polymerization are not particularly limited, and for example, the above-mentioned photopolymerization initiators and chain-transfer agents may be used.

The polymerization ratio of the prepolymer is not particularly limited, but it is preferably 3 to 50% by weight, more preferably 5 to 40% by weight for adjusting a viscosity of the prepolymer syrup suitable for application onto a base material. The polymerization ratio of the prepolymer can be adjusted to fall within a desired range by adjusting the type and used amount of a photopolymerization initiator, the irradiation intensity/irradiation time of an active ray such as UV light, and so on.

Other monomer component that forms an acrylic base polymer, and a polymerization initiator, a chain-transfer agent, a silane coupling agent, a crosslinker and the like as necessary are mixed with the prepolymer composition to form a pressure sensitive adhesive composition. Preferably, the monomer component added in post-polymerization is a polyfunctional monomer. The monomer component added in post-polymerization may contain a monofunctional monomer in addition to a polyfunctional monomer.

The photopolymerization initiator and the chain-transfer agent to be used for post-polymerization are not particularly limited, and for example, the above-mentioned photopolymerization initiators and chain-transfer agents may be used. When the polymerization initiator in preliminary polymerization is not deactivated and remains in the prepolymer composition, addition of the polymerization initiator for post-polymerization may be omitted.

A crosslinker may be used to introduce crosslinked structure into the base polymer of the pressure sensitive adhesive. The crosslinked structure is formed by, for example, adding a crosslinker after polymerization of the base polymer or after preliminary polymerization. As the crosslinker, a common cross linker can be used, such as an isocyanate-based crosslinker, an epoxy-based crosslinker, an oxazoline-based crosslinker, an aziridine-based crosslinker, a carbodiimide-based crosslinker or a metal chelate-based crosslinker.

The content of the crosslinker is normally 0 to 5 parts by weight, preferably 0 to 3 parts by weight based on 100 parts by weight of the acrylic base polymer. If the content of the crosslinker is excessively high, the gel fraction of the pressure sensitive adhesive may excessively increase to cause ingress of bubbles in the vicinity of the printing level difference, and display unevenness.

When the pressure sensitive adhesive composition includes a crosslinker, it is preferred to perform a heating for crosslinking to form crosslinked structure before bonding to an adherend. The heating temperature and the heating time in the crosslinking treatment are appropriately set according to a type of crosslinker to be used, and crosslinking is normally performed by heating at 20° C. to 160° C. for 1 minute to about 7 days.

The molecular weight of the base polymer is appropriately adjusted so that the characteristics such as an elastic modulus satisfy the above-mentioned respective requirements. The base polymer of the first pressure sensitive adhesive layer preferably has a weight average molecular weight of about 50,000 to 1,000,000, more preferably 100,000 to 1,000,000 in terms of polystyrene. The base polymer of the second pressure sensitive adhesive layer preferably has a weight average molecular weight of about 500,000 to 5,000,000, more preferably 800,000 to 4,000,000 in terms of polystyrene. The weight average molecular weight of the base polymer of the second pressure sensitive adhesive layer is preferably larger than the weight average molecular weight of the base polymer of the first pressure sensitive adhesive layer.

Preferably, the first pressure sensitive adhesive layer and the second pressure sensitive adhesive layer each contain silane coupling agent in the pressure sensitive adhesive composition. When both the first pressure sensitive adhesive layer and the second pressure sensitive adhesive layer contain silane coupling agent, adhesive strength at the interface between the pressure sensitive adhesive layers is improved, so that delamination at the interface between pressure sensitive adhesives in the laminated pressure sensitive adhesive sheet is suppressed. Silane coupling agents may be used alone, or in combination of two or more thereof. The content of the silane coupling agent in the pressure sensitive adhesive is preferably 0.01 to 5 parts by weight, more preferably 0.05 to 2 parts by weight, further preferably 0.1 to 1 part by weight based on total 100 parts by weight of the acrylic base polymer.

The pressure sensitive adhesive composition may contain a tackifier as necessary. As the tackifier, for example, a terpene-based tackifier, a styrene-based tackifier, a phenol-based tackifier, a rosin-based tackifier, an epoxy-based tackifier, a dicyclopentadiene-based tackifier, a polyamide-based tackifier, a ketone-based tackifier, an elastomer-based tackifier or the like can be used.

In addition to the components exemplified above, additives such as a plasticizer, a softener, a degradation inhibitor, a filler, a colorant, an ultraviolet ray absorber, an antioxidant, a surfactant and an antistatic agent may be added in the pressure sensitive adhesive composition within the bounds of not impairing the characteristics of the pressure sensitive adhesive.

<Formation of Pressure Sensitive Adhesive Layer>

As the method for forming the pressure sensitive adhesive layer, various kinds of methods are used. Specific examples include roll coating, kiss roll coating, gravure coating, reverse coating, roll brushing, spray coating, dip roll coating, bar coating, knife coating, air knife coating, curtain coating, lip coating, and extrusion coating methods using a die coater etc. Among them, use of a die coater is preferred, and in particular, use of a die coater using a fountain die or a slot die is more preferred.

When the base polymer of the pressure sensitive adhesive composition is a solution-polymerized polymer, the solvent is preferably dried after application of the composition. As a method for drying, a suitable method can be appropriately employed according to a purpose. The heating/drying temperature is preferably 40° C. to 200° C., more preferably 50° C. to 180° C., further preferably 70° C. to 170° C. Drying time can be appropriately set. The drying time is preferably 5 seconds to 20 minutes, more preferably 5 seconds to 15 minutes, further preferably 10 seconds to 10 minutes.

When the pressure sensitive adhesive composition includes a crosslinker, a heating for crosslinking may be performed after the pressure sensitive adhesive composition is applied on the substrate. The heating temperature and the heating time are appropriately set according to a type of crosslinker to be used, and crosslinking is normally performed by heating at 20° C. to 160° C. for 1 minute to about 7 days. Heating for drying the pressure sensitive adhesive after application may serve may also serve as heating for crosslinking.

Protective sheet is releasably attached on the pressure sensitive adhesive layer, as necessary. The protective sheet is provided for protecting the exposed surface of the pressure sensitive adhesive layer, until the pressure sensitive adhesive is bonded to adherend. A substrate used for formation (application) of the pressure sensitive adhesive layer may be used as it is as a protective sheet.

As the protective sheets, a plastic film made of polyethylene, polypropylene, polyethylene terephthalate, polyester, or the like is preferably used. The thickness of each of the protective sheets is normally 5 to 200 μm, preferably about 10 to 150 μm. The protective sheet may be subjected to release and antifouling treatments with a silicone-based, fluorine-based, long-chain alkyl-based or fatty acid amide-based releasing agent, a silica powder or the like, and an antistatic treatment of coating type, kneading type, vapor deposition type or the like. Particularly, by appropriately subjecting the surface of the protective sheet to a release treatment with using silicone, long-chain alkyl, fluorine or the like, releasability from the pressure sensitive adhesive layers can be further improved in practical use.

The method for laminating the first pressure sensitive adhesive layer and the second pressure sensitive adhesive layer is not particularly limited. Each of the first pressure sensitive adhesive layer and the second pressure sensitive adhesive layer may be separately formed as a pressure sensitive adhesive sheet, followed by bonding both the layers together, or one of the pressure sensitive adhesive layers may be formed as a pressure sensitive adhesive sheet, followed by coating the pressure sensitive adhesive sheet with the other pressure sensitive adhesive layer to provide a laminated pressure sensitive adhesive sheet. A composition for formation of the first pressure sensitive adhesive layer and a composition for formation of the second pressure sensitive adhesive layer may be co-extruded to form a laminated pressure sensitive adhesive sheet.

[Optical Film with Pressure Sensitive Adhesive]

As described above, the laminated pressure sensitive adhesive sheet 20 according to the present invention is a front-side pressure sensitive adhesive sheet for bonding the front transparent member to the viewing-side of the polarizing plate. When the laminated pressure sensitive adhesive sheet 20 is formed on the optical film 10 including a polarizing plate, it can be used as an optical film with pressure sensitive adhesive. In the optical film with pressure sensitive adhesive, the first pressure sensitive adhesive layer 21 side is arranged on the optical film 10 as shown in FIG. 2.

<Optical Film>

The optical film 10 includes a polarizing plate. As the polarizing plate, one having an appropriate transparent protective film laminated on one surface or both surfaces of a polarizer as necessary is generally used. The polarizer is not particularly limited, and various kinds of polarizers may be used. Examples of the polarizer include films obtained by impregnating a dichroic material such as iodine or a dichroic dye into a hydrophilic polymer film such as a polyvinyl alcohol-based film, a partially formalized polyvinyl alcohol-based film or an ethylene-vinyl acetate copolymer-based partially saponified film, and uniaxially stretching the film; and polyene-based oriented films such as those of dehydrated products of polyvinyl alcohol and dehydrochlorinated products of polyvinyl chloride.

For the transparent protective film as a protective film for the polarizer, a resin excellent in transparency, mechanical strength, thermal stability, moisture barrier property and optical isotropy, such as a cellulose-based resin, a cyclic polyolefin-based resin, an acryl-based resin, a phenylmaleimide-based resin or a polycarbonate-based resin, is preferably used. When a transparent protective film is provided on each of both surfaces of the polarizer, protective films formed of the same polymer material may be used or protective films formed of different polymer materials may be used on the front surface and the back surface. For the purpose of, for example, optical compensation and wide viewing of a liquid crystal cell, an optically anisotropic film such as a retardation sheet (stretched film) can also be used as a protective film for the polarizer.

The optical film 10 may be consisting of the polarizing plate. The optical film 10 may include other films laminated on one surface or both surfaces of the polarizing plate with an appropriate adhesive layer or a pressure sensitive adhesive layer interposed therebetween as necessary. The type of the films laminated on the polarizing plate is not particularly limited. Films generally used for formation of an image display device, such as retardation sheets, wide-viewing films, viewing angle restriction (peep prevention) films and brightness enhancement films may be laminated on the polarizing plate. For example, in the liquid crystal display device, an optical compensation film may be arranged between the image display cell (liquid crystal cell) and the polarizing plate for the purpose of, for example, improving viewing angle properties by appropriately changing the polarized state of light emitted from the liquid crystal cell to the viewing-side. In the organic EL display device, a quarter wave plate may be arranged between the cell and the polarizing plate for the purpose of inhibiting external light from being reflected at a metal electrode layer to cause the surface to be viewed like a mirror surface. When a quarter wave plate is arranged on a viewing-side of the polarizing plate, linearly polarized light emitted from the polarizing plate is converted into circularly polarized light, so that a proper displayed image can be made visible even to a viewer wearing polarizing sunglasses.

A surface of the optical film 10 may be provided with a hard coat layer, or subjected to an antireflection treatment, or a treatment intended for prevention of sticking, diffusion or antiglare. A surface of the optical film 10 may be subjected to a surface modification treatment for the purpose of, for example, improving adhesiveness before the pressure sensitive adhesive layers 21 and 22 are provided thereon. Specific examples of the treatment include a corona treatment, a plasma treatment, a flame treatment, an ozone treatment, a primer treatment, a glow treatment, a saponification treatment, and a treatment with a coupling agent. An antistatic layer may also be formed.

<Formation of Optical Film with Pressure Sensitive Adhesive>

The method for forming the laminated pressure sensitive adhesive sheet 20 on the optical film 10 is not particularly limited. The laminated pressure sensitive adhesive sheet 20 shown in FIG. 1 may be formed beforehand, and bonded onto the first main surface of the optical film 10 after the protective sheet 41 on the first pressure sensitive adhesive layer 21 side is released, or the first pressure sensitive adhesive layer 21 and the second pressure sensitive adhesive layer 22 may be sequentially bonded onto the optical film 10. A composition for formation of the first pressure sensitive adhesive layer may be applied onto the first main surface of the optical film to form the first pressure sensitive adhesive layer thereon, followed by forming the second pressure sensitive adhesive layer by application or transfer. An optical film with pressure sensitive adhesive can also be obtained by forming a laminated pressure sensitive adhesive sheet on the first main surface of the optical film 10 by co-extrusion of a composition for formation of the first pressure sensitive adhesive layer and a composition for formation of the second pressure sensitive adhesive layer.

[Optical Film with Pressure Sensitive Adhesive on Both Sides]

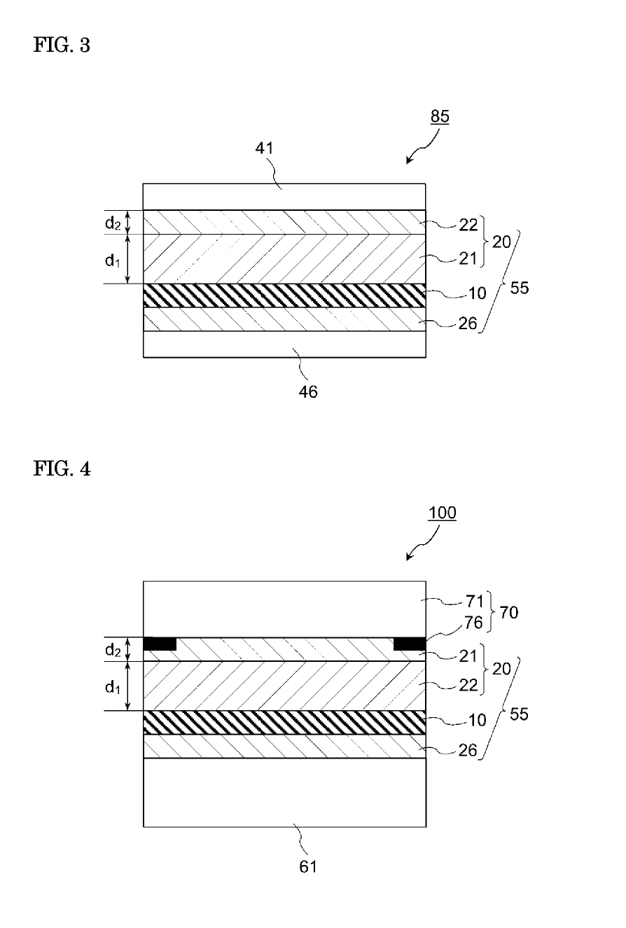

The laminated pressure sensitive adhesive sheet 20 according to the present invention is provided on the first main surface of the optical film 10. A different pressure sensitive adhesive sheet (cell-side pressure sensitive adhesive sheet) 26 may be provided on the second main surface, so that an optical film with pressure sensitive adhesive on both sides as shown in FIG. 3 is provided. In the embodiment shown in FIG. 3, the protective sheet 41 is releasably attached on the front-side pressure sensitive adhesive sheet 20 (laminated pressure sensitive adhesive sheet) of an optical film with pressure sensitive adhesive on both sides 55, and the protective sheet 46 is releasably attached on the cell-side pressure sensitive adhesive sheet 26.

By using an optical film with pressure sensitive adhesive on both sides in which a pressure sensitive adhesive layer is provided on each of both main surfaces of the optical film 10 as described above, a step of providing a separate sheet on the optical film after bonding the optical film to a surface of an image display cell can be omitted, so that the production process of the image display device can be simplified.

<Cell-Side Pressure Sensitive Adhesive Sheet>

Thickness of the cell-side pressure sensitive adhesive sheet 26 is preferably 3 to 30 μm, more preferably 5 to 27 μm, further preferably 10 to 25 μm. For the cell-side pressure sensitive adhesive sheet, various kinds of pressure sensitive adhesives that are used for bonding the optical film and the image display cell to each other can be used. As the pressure sensitive adhesive that forms the cell-side pressure sensitive adhesive sheet, an acryl-based pressure sensitive adhesive is preferably used.

The storage elastic modulus G′₂₀ of the cell-side pressure sensitive adhesive sheet 26 at 20° C. is preferably 1×10⁴ Pa to 1×10⁷ Pa, more preferably 5×10⁴ Pa to 5×10⁶ Pa, further preferably 1×10⁵ Pa to 1×10⁶ Pa. When the storage elastic modulus G′₂₀ of the cell-side pressure sensitive adhesive sheet falls within the above-mentioned range, moderate adhesiveness is exhibited, and transfer of the pressure sensitive adhesive to a cutting blade and cracking/chipping in the pressure sensitive adhesive during cutting can be suppressed.

[Image Display Device]

FIG. 4 is a sectional view showing one embodiment of an image display device. The optical film with pressure sensitive adhesive according to the present invention is suitably used for formation of the image display device 100 which includes the front transparent member 70 such as a touch panel or a front transparent plate on one surface (viewing-side) of the optical film 10 including a polarizing plate, and includes the image display cell 61 such as a liquid crystal cell or an organic EL cell on the other surface. The laminated pressure sensitive adhesive sheet 20 is used for bonding the optical film 10 including a polarizing plate and the front transparent member 70 such as a touch panel or a front transparent plate.

The front transparent member 70 is, for example, a front transparent plate (window layer) or a touch panel. As the front transparent plate, a transparent plate having appropriate mechanical strength and thickness. As the transparent plate, for example, a transparent resin plate such as that of an acryl-based resin or a polycarbonate-based resin, or a glass plate is used. As the touch panel, a touch panel of any type such as resistive film type, capacitance type, optical type or ultrasonic type is used.

When the optical film with pressure sensitive adhesive on both sides as shown in FIG. 3 is used, the method for bonding the image display cell 61 to the optical film with pressure sensitive adhesive 55, and the method for bonding the front transparent member 70 to the optical film with pressure sensitive adhesive 55 are not particularly limited. The bonding can be performed by various kinds of known methods, after the protective sheets 41 and 46 attached on the surfaces of the front-side pressure sensitive adhesive sheet 20 and the cell-side pressure sensitive adhesive sheet 26, respectively, are peeled off.

The order of bonding is not particularly limited. Bonding of the image display cell 61 to the cell-side pressure sensitive adhesive sheet 26 of the optical film with pressure sensitive adhesive 55 may precede, or bonding of the front transparent member 70 to the front-side pressure sensitive adhesive sheet 20 of the optical film with pressure sensitive adhesive 55 may precede. The former bonding and the latter bonding may be performed in parallel. For improving workability in bonding and axis precision of the optical film, it is preferred that a cell-side bonding step of bonding the optical film 10 and the image display cell 61 to each other with the cell-side pressure sensitive adhesive sheet 26 interposed therebetween after peeling off the protective sheet 46 from the surface of the cell-side pressure sensitive adhesive sheet 26 is performed, followed by a viewing-side bonding step of peeling off the protective sheet 41 from the surface of the front-side pressure sensitive adhesive sheet 20, and bonding the optical film 10 and the front transparent member 70 to each other with the laminated pressure sensitive adhesive sheet 20 interposed therebetween.

It is preferred to perform degassing for removing bubbles at the interface between the second pressure sensitive adhesive layer 22 and the front transparent member 70, and in the vicinity of a non-flat portion such as the printed portion 76 on the front transparent member 70 after the optical film and the front transparent member are bonded to each other. As a degassing method, an appropriate method such as heating, pressurization or pressure reduction can be employed. For example, it is preferred that bonding is performed while ingress of bubbles is suppressed under reduced pressure and heating, and pressurization is then performed in parallel with heating through autoclave or the like for the purpose of, for example, suppressing delay bubbles.

As described above, ingress of bubbles in the vicinity of the printing level difference of the front transparent member, and occurrence of display unevenness can be suppressed by using the laminated pressure sensitive adhesive sheet, and an optical film with pressure sensitive adhesive which includes the laminated pressure sensitive adhesive sheet. Even if outgas is generated from the front transparent member due to use in a high-temperature environment, remaining of bubbles at the interface between the front transparent member and the pressure sensitive adhesive sheet is suppressed. Therefore, according to the present invention, an image display device excellent in visibility is obtained.

### EXAMPLES

The present invention will be described more specifically below by showing examples and comparative examples, but the present invention is not limited to these examples.

[Preparation of Pressure Sensitive Adhesive Sheet]

<Pressure Sensitive Adhesive Sheet A>

(Preparation of Pressure Sensitive Adhesive Composition)

40 parts by weight of 2-ethylhexyl acrylate (2EHA), 40 parts by weight of isostearyl acrylate (ISA), 10 parts by weight of N-vinylpyrrolidone (NVP) 10 part by weight of 4-hydroxybutyl acrylate (4HBA), and 0.1 part by weight of 1-hydroxy-cyclohexyl-phenyl-ketone (trade name “IRGACURE 184”, manufactured by BASF Japan Ltd.) as a photopolymerization initiator were put into a reaction container provided with a thermometer, a stirrer, a cooling tube and a nitrogen gas inlet. Irradiation of an ultraviolet ray was performed under a nitrogen atmosphere to obtain a prepolymer composition having a polymerization ratio of 10%. To this prepolymer composition, 0.15 part by weight of trimethylolpropane triacrylate (TMPTA) as a polyfunctional monomer, and 0.3 part by weight of 3-Glycidyloxypropyltrimethoxysilane (trade name “KBM-403” manufactured by Shin-Etsu Chemical Co., Ltd.) as a silane coupling agent were added. These components were then uniformly mixed to prepare a pressure sensitive adhesive composition A.

(Formation of Pressure Sensitive Adhesive Sheet)

On a silicone release-treated surface of a 75 μm-thick polyester film, the pressure sensitive adhesive composition A was applied so as to have a thickness of 175 μm, and a silicone release-treated surface of a 38 μm-thick polyester film was bonded thereonto. Thereafter, from above a surface on the silicone release-treated 38 μm-thick polyester film, UV irradiation was performed until the integrated light amount reached 3000 mJ/cm² using a black light regulated in position so that the irradiation intensity at the irradiation surface immediately below the lamp was 5 mW/cm², thereby advancing polymerization to prepare an acryl-based pressure sensitive adhesive sheet A having a thickness of 175 μm.

<Pressure Sensitive Adhesive Sheets B, C and D>

Except that the composition of monomers and the added amount of the polyfunctional monomer were changed as shown in Table 1, the same procedure as in the case of the pressure sensitive adhesive composition A was carried out to prepare pressure sensitive adhesive compositions B, C and D. Using this pressure sensitive adhesive composition, the same procedure as in the case of the pressure sensitive adhesive sheet A was carried out to obtain pressure sensitive adhesive sheets B, C and D each having a thickness of 175 μm.

<Pressure Sensitive Adhesive Sheets E and F>

Except that the composition of monomers and the added amount of the polyfunctional monomer were changed as shown in Table 1, the same procedure as in the case of the pressure sensitive adhesive composition A was carried out to prepare pressure sensitive adhesive compositions E and F. Except that this pressure sensitive adhesive composition was used, the application thickness was changed to 25 μm, and the integrated light amount in UV irradiation was changed to 1000 mJ/cm², the same procedure as in the case of the pressure sensitive adhesive sheet A was carried out to obtain pressure sensitive adhesive sheets E and F.

<Pressure Sensitive Adhesive Sheets A1 and A2>

Using the pressure sensitive adhesive composition A, the same procedure as in the case of the pressure sensitive adhesive sheet A was carried out to obtain pressure sensitive adhesive sheets A1 and A2, except that the application thickness was changed to 200 μm and 150 μm, respectively.

<Pressure Sensitive Adhesive Sheet B1>

Using the pressure sensitive adhesive composition B, the same procedure as in the case of the pressure sensitive adhesive sheet B was carried out to obtain pressure sensitive adhesive sheet B1, except that the application thickness was changed to 200 μm.

<Pressure Sensitive Adhesive Sheet E1>

Using the pressure sensitive adhesive composition E, the same procedure as in the case of the pressure sensitive adhesive sheet E was carried out to obtain pressure sensitive adhesive sheet E1, except that the application thickness was changed to 200 μm, and the integrated light amount in UV irradiation was changed to 3000 mJ/cm².

<Pressure Sensitive Adhesive Sheet F1>

Using the pressure sensitive adhesive composition F, the same procedure as in the case of the pressure sensitive adhesive sheet F was carried out to obtain pressure sensitive adhesive sheet F1, except that the application thickness was changed to 200 μm, and the integrated light amount in UV irradiation was changed to 3000 mJ/cm².

<Pressure Sensitive Adhesive Sheets F2 and F3>

Using the pressure sensitive adhesive composition F, the same procedure as in the case of the pressure sensitive adhesive sheets F2 and F3 was carried out to obtain pressure sensitive adhesive sheet F, except that the application thickness was changed to 12 μm and 50 μm, respectively.

<Cell-Side Pressure Sensitive Adhesive Sheet>

(Preparation of Pressure Sensitive Adhesive Composition)

97 parts by weight of butyl acrylate (BA) and 3 parts by weight of acrylic acid (AA) as monomer components, 0.2 part by weight of azobisisobutyronitrile (AIBN) as a thermopolymerization initiator, and 233 parts by weight of ethyl acetate were put into a reaction container provided with a thermometer, a stirrer, a cooling tube and a nitrogen gas inlet. Nitrogen purge was performed for 1 hour while the mixture was stirred under nitrogen atmosphere at 23° C. Thereafter, the mixture was reacted at 60° C. for 5 hours to obtain an acrylic base polymer having a weight average molecular weight (Mw) of 1,100,000. To this acrylic base polymer solution, 0.8 part by weight of trimethylolpropane tolylene diisocyanate (trade name “CORONATE L”, manufactured by Nippon Polyurethane Industry Co., Ltd.) as an isocyanate-based crosslinker and 0.1 part by weight of a silane coupling agent (trade name “KBM-403”, manufactured by Shin-Etsu Chemical Co., Ltd.) were added to prepare a pressure sensitive adhesive composition (solution).

(Formation of Pressure Sensitive Adhesive Sheet and Crosslinking)

The above prepared pressure sensitive adhesive composition was applied on a silicone release-treated surface of a 38 μm-thick polyester film so as to have a thickness of 20 μm after drying, and dried at 100° C. for 3 minutes to remove the solvent to obtain a pressure sensitive adhesive sheet. Thereafter, heating was carried out at 50° C. for 48 hours to perform a crosslinking treatment to obtain a cell-side pressure sensitive adhesive sheet.

[Evaluation Methods of Pressure Sensitive Adhesive and Pressure Sensitive Adhesive Sheet]

<Gel Fraction of Pressure Sensitive Adhesive>

Pressure sensitive adhesive sheet was cut to a size of 40 mm×40 mm and wrapped in a porous polytetrafluoroethylene film (manufactured by Nitto Denko Corporation; trade name: “NTF-1122”; thickness: 85 μm) cut to a size of 100 mm×100 mm, and the wrapped opening was tied with a kite string (1.5 mm (thickness)×100 mm (length)). The total weight (A) of the porous polytetrafluoroethylene film and the kite string measured beforehand was subtracted from the weight of this sample to calculate the weight (B) of the pressure sensitive adhesive sample. The pressure sensitive adhesive sample wrapped in the porous polytetrafluoroethylene film was immersed in approximately 50 mL of ethyl acetate at 23° C. for 7 days to elute sol components of the pressure sensitive adhesive to the outside of the polytetrafluoroethylene film. After immersion, the pressure sensitive adhesive wrapped in the porous polytetrafluoroethylene film was taken out, dried at 130° C. for 2 hours, and allowed to cool for about 20 minutes, and the dry weight (C) was measured. The gel fraction of the pressure sensitive adhesive was calculated from the following formula.

gel fraction (%)=100×(C−A)/B

<Storage Elastic Modulus of Pressure Sensitive Adhesive Sheet>

A plurality of pressure sensitive adhesive sheets were laminated to a thickness of about 1.5 mm, and the laminate thus obtained was used as a sample for measurement. For measurement of the storage elastic modulus of the laminated pressure sensitive adhesive sheet, first pressure sensitive adhesive layers and second pressure sensitive adhesive layers were alternately laminated to a thickness of about 1.5 mm, and the laminate thus obtained was used as a sample for measurement. The dynamic viscoelasticity was measured under the following conditions using “Advanced Rheometric Expansion System (ARES)” manufactured by Rheometric Scientific, Inc., and storage elastic moduli (G′₂₀, G′₁₀₀ and G′₁₅₀) at 20° C., 100° C. and 150° C. were read from the measurement results.

(Measurement Conditions)

Deformation mode: torsion

Measurement Frequency: 1 Hz

Temperature elevation rate: 5° C./minute

Measurement temperature: −50 to 150° C.

Shape: parallel plate (8.0 mm φ)

<Residual Stress of Pressure Sensitive Adhesive Sheet>

A sheet piece of 40 mm×40 mm was cut out from the pressure sensitive adhesive sheet, rounded in the form of a column, and used as a measurement sample. In a tension tester, the chuck-to-chuck distance was adjusted to 20 mm, the measurement sample was set, and stretched to a strain of 300% (chuck-to-chuck distance: 80 mm) at a tension speed of 200 mm/minute under a measurement temperature of 25° C., and the stress (tensile stress) after elapse of 180 seconds with the chuck position being fixed was defined as a residual stress.

<Weight Average Molecular Weight>

The weight average molecular weight (Mw) of the base polymer was measured by a GPC (gel permeation chromatography) apparatus (product name “HLC-8120GPC”) manufactured by TOSOH CORPORATION. The base polymer was dissolved in tetrahydrofuran to prepare a 0.1 wt % solution, this solution was filtered with a 0.45 μm membrane filter, and the resulting filtrate was used as a measurement sample. GPC measurement conditions are as follows.

(Measurement Conditions)

Column: G7000HXL+GMHXL+GMHXL manufactured by TOSOH CORPORATION

Column size: each 7.8 mmφ×30 cm (total column length: 90 cm)

Column temperature: 40° C. Flow rate: 0.8 mL/min

Injection amount: 100 μL

Eluent tetrahydrofuran

Detector: differential refractometer (RI)

Standard sample: polystyrene

[Evaluation Result of Pressure Sensitive Adhesive Sheet (Single Layer)

Properties of the pressure sensitive adhesive sheets A to F (single layer), and composition of each of the pressure sensitive adhesives therein are shown in Table 1. In Table 1, each of the components is described by abbreviation indicated below.

2EHA: 2-ethylhexyl acrylate

ISA: isostearyl acrylate

MMA: methyl methacrylate

AA: Acrylic acid

NVP: N-vinylpyrrolidone

VA: Vinyl acetate

4HBA: 4-hydroxybutyl acrylate

2HEA: 2-hydroxyethyl acrylate

TMPTA: trimethylolpropane triacrylate

TABLE 1

| | | | Pressure sensitive adhesive sheet | | | | | |
|---|---|---|---|---|---|---|---|---|
| | | | A | B | C | D | E | F |
| Composition of | Composition of | 2EHA | 40 | 70 | 80 | 70 | 90 | 70 |
| pressure sensitive | prepolymer | ISA | 40 | — | — | — | — | — |
| adhesive | | MMA | — | — | — | — | — | — |
| (parts by weight) | | AA | — | — | — | 5 | 10 | — |
| | | NVP | 10 | — | 10 | — | — | 18 |
| | | VA | — | — | — | 25 | — | — |
| | | 4HBA | 10 | — | 10 | — | — | — |
| | | 2HEA | — | 30 | — | — | — | 12 |
| | Polyfunctional | TMPTA | 0.15 | 0.12 | 0.08 | 0.15 | 0.3 | 0.3 |
| | monomer | | | | | | | |
| | Silane coupling | KBM-403 | 0.3 | 0.3 | 0.3 | 0.3 | 0.3 | 0.3 |
| | agent | | | | | | | |

| | | | | | | | |
|---|---|---|---|---|---|---|---|
| Characteristics of | Gel fraction (% by weight) | 38 | 47 | 52 | 47 | 90 | 88 |
| pressure sensitive | Mw (×10⁴) | 18 | 30 | 180 | 20 | 230 | 150 |
| adhesive sheet | G′₂₀ (×10⁴ Pa) | 17 | 23 | 18 | 27 | 22 | 20 |
| (single-layer) | G′₁₀₀ (×10⁴ Pa) | 0.7 | 0.9 | 3 | 1.2 | 8 | 11 |
| | G′₁₅₀ (×10⁴ Pa) | 0.4 | 0.7 | 2 | 0.9 | 7 | 10 |
| | G′₂₀/G′₁₀₀ | 24.3 | 25.6 | 6.0 | 22.5 | 2.8 | 1.8 |
| | G′₂₀/G′₁₅₀ | 42.5 | 32.9 | 9.0 | 30.0 | 3.1 | 2.0 |
| | Residual stress (N/cm²) | 1.3 | 2.1 | 3.5 | 4.0 | 8.0 | 9.0 |

### Example 1

As an optical film, a polarizing plate including a transparent protective film on each of both surfaces of a polarizer composed of a 25 μm-thick iodine dyed stretched polyvinyl alcohol film was used. The cell-side pressure sensitive adhesive sheet was bonded to one surface (cell-side surface) of the polarizing plate using a roll laminator. Thereafter, the pressure sensitive adhesive sheet A was bonded to the other surface (viewing-side surface) of the polarizing plate using a roll laminator. Further, the pressure sensitive adhesive sheet E was bonded onto the pressure sensitive adhesive sheet A using a roll laminator. In this way, a polarizing plate with pressure sensitive adhesive on both sides was obtained in which the cell-side pressure sensitive adhesive sheet was provided on one surface of the polarizing plate, a laminated pressure sensitive adhesive sheet of the pressure sensitive adhesive sheet A and the pressure sensitive adhesive sheet E was provided on the other surface of the polarizing plate, and a protective film was temporarily attached on each of the surface of the cell-side pressure sensitive adhesive sheet and the surface of the viewing-side laminated pressure sensitive adhesive sheet.

### Examples 2 to 7 and Comparative Example 1

Except that the configuration of the pressure sensitive adhesive sheet to be bonded on the viewing-side surface of the polarizing plate was changed as shown in Table 2, the same procedure as in Example 1 was carried out to obtain a polarizing plate with pressure sensitive adhesive on both sides.

### Comparative Examples 2 to 5

Except that the pressure sensitive adhesive sheet to be bonded on the viewing-side surface of the polarizing plate was changed to a 200 μm-thick pressure sensitive adhesive sheet composed of a single layer of the pressure sensitive adhesive sheets A1, B1, C1 and D1, the same procedure as in Example 1 was carried out to obtain a polarizing plate with pressure sensitive adhesive on both sides.

[Evaluation]

<Outgas Bubble Reliability>

The polarizing plate with pressure sensitive adhesive on both sides was cut to a size of 45 mm×80 mm, the protective film on the viewing-side surface was then released, the polarizing plate was bonded to a surface-cured 1 mm-thick acrylic plate (ACRYLITE MR-200 manufactured by Mitsubishi Rayon Co., Ltd.) using a hand roller, and an autoclave treatment (50° C., 0.5 MPa, 15 minutes) was performed. The sample was heated in a drying oven at 85° C. for 24 hours, and then taken out from the oven, and the external appearance thereof was visually observed. Samples for which bubbles were not observed were rated “good,” and samples for which bubbles having no foreign matter as a nucleus were observed were rated “bad.”

<Display Unevenness>

(Preparation of Image Display Device for Evaluation)

A backlight was removed from a replacement upper liquid crystal panel of Nintendo 3DS, a polarizing plate on a side opposite to the backlight side of the liquid crystal panel was removed from a liquid crystal cell, and a pressure sensitive adhesive on the cell surface was then removed using a clean cloth impregnated with ethanol. A polarizing plate with pressure sensitive adhesive on both sides was cut to a size of 50 mm×80 mm and a protective film on a cell-side pressure sensitive adhesive sheet was peeled off. Thereafter, the cell-side pressure sensitive adhesive sheet surface was superimposed on the central part of the liquid crystal cell surface, and pressed with a hand roller to bond the optical film and the liquid crystal cell to each other.

Thereafter, the protective film on the viewing-side pressure sensitive adhesive was peeled off, and a printed surface of a glass plate (0.7 mm×50 mm×1000 mm), the peripheral edge of which was printed with a black ink in the form of a frame (ink printing thickness: 15 μm; ink printing width on each of both short sides (long side direction): 15 mm, ink printing width on each of both long sides (short side direction): 5 mm), was placed on an exposed surface of the pressure sensitive adhesive. The optical film and the glass plate were bonded to each other by a vacuum thermocompression bonding device (temperature: 25° C.; pressure in device: 50 Pa; pressure: 0.3 MPa; pressure retention time: 10 seconds). Thereafter, an autoclave treatment was performed (50° C., 0.5 MPa, 15 minutes). The obtained panel for evaluation was replaced by an image display panel of the main body of Nintendo 3DS, and electrical connection was performed to obtain an image display device for evaluation. Whether or not display unevenness occurred in the vicinity of the printed frame was visually checked when the panel was made to provide white image. Samples for which display unevenness was not observed were rated “good,” samples for which slight display unevenness was observed were rated “moderate,” and samples for which display unevenness was readily observed were rated “bad.”

<Cloudiness of Pressure Sensitive Adhesive Sheet Under High-Humidity Environment>

The image display device for evaluation was placed in a thermohygrostat at 60° C. and 95% RH for 240 hours. Thereafter, the sample was taken out, and stored in an environment at 25° C. and 50% RH for 24 hours, followed by visually checking whether the pressure sensitive adhesive layer was clouded or not. In Examples 1 to 6, cloudiness of the pressure sensitive adhesive layer was not observed, whereas in Example 7 where neither the first pressure sensitive adhesive layer nor the second pressure sensitive adhesive layer contained a hydroxy group-containing monomer in the base polymer, cloudiness was observed. This result shows that by using a hydroxy group-containing monomer in the base polymer, cloudiness can be suppressed even if the pressure sensitive adhesive sheet is exposed to a high-humidity environment.

<Delamination Test of Laminated Pressure Sensitive Adhesive Sheet>

A laminated pressure sensitive adhesive sheet was prepared by bonding the first pressure sensitive adhesive layer and the second pressure sensitive adhesive layer using a hand roller. The laminated pressure sensitive adhesive sheet was cut to a size of 25 mm (width)×100 mm (length), a polyester film having a width of 25 mm, a length of 250 mm and a thickness of 25 μm was bonded to a surface on the first pressure sensitive adhesive layer-side, and a surface on the second pressure sensitive adhesive layer-side was bonded to a glass plate using a hand roller to provide a test piece. In a tension tester, the end of the glass plate and the end of the polyester film were held by a chuck, the polyester film was peeled at 180° at a tension speed of 1000 mm/minute, and an interface at which delamination occurred was identified. Samples in which delamination occurred at the interface between the first pressure sensitive adhesive layer and the second pressure sensitive adhesive layer were determined as being “delaminated,” and samples in which delamination occurred at the interface between the glass and the second pressure sensitive adhesive layer were determined as being “not delaminated.”

Delamination between the pressure sensitive adhesive layers was not observed in any of Examples 1 to 7 and Comparative Example 1. On the other hand, when a pressure sensitive adhesive A which did not contain silane coupling agent was used in place of the pressure sensitive adhesive A in Examples 1 and 2, delamination was observed in the delamination test. When a pressure sensitive adhesive B′ which did not contain silane coupling agent was used in place of the pressure sensitive adhesive B in Examples 3 and 4, delamination was observed. When a pressure sensitive adhesive E′ which did not contain silane coupling agent was used in place of the pressure sensitive adhesive E in Examples 1 and 3, delamination was observed, and when a pressure sensitive adhesive F′ which did not contain silane coupling agent was used in place of the pressure sensitive adhesive F in Examples 2 and 4, delamination was observed. From these results, it is apparent that for suppressing delamination of the pressure sensitive adhesive, it is effective to incorporate silane coupling agent in both the first pressure sensitive adhesive layer and the second pressure sensitive adhesive layer that form the laminated pressure sensitive adhesive sheet.

[Evaluation Results]

Table 2 shows the laminated structure of the viewing-side pressure sensitive adhesive layer in the polarizing plate with pressure sensitive adhesive on both sides, the properties of the laminated pressure sensitive adhesive sheet (properties of the single-layer pressure sensitive adhesive sheet for Comparative Examples 2 to 5), and evaluation results of bubble reliability and display unevenness in each of the Examples and Comparative Examples.

TABLE 2

| | | Example 1 | Example 2 | Example 3 | Example 4 | Example 5 | Example 6 | Example 7 |
|---|---|---|---|---|---|---|---|---|
| First | Type | A | A | B | B | A1 | A2 | D |
| pressure | Thickness (μm) | 175 | 175 | 175 | 175 | 200 | 150 | 175 |
| sensitive | OH-containing monomer | Present | Present | Present | Present | Present | Present | Absent |
| adhesive | Gel fraction (wt %) | 38 | 38 | 47 | 47 | 38 | 38 | 47 |
| layer | G′₂₀ (×10⁴ Pa) | 17 | 17 | 23 | 23 | 17 | 17 | 27 |
| | G′₁₀₀ (×10⁴ Pa) | 0.7 | 0.7 | 0.9 | 0.9 | 0.7 | 0.7 | 1.2 |
| | G′₁₅₀ (×10⁴ Pa) | 0.4 | 0.4 | 0.7 | 0.7 | 0.4 | 0.4 | 0.9 |
| | G′₂₀/G′₁₀₀ | 24.3 | 24.3 | 25.6 | 25.6 | 24.3 | 24.3 | 22.5 |
| | G′₂₀/G′₁₅₀ | 42.5 | 42.5 | 32.9 | 32.9 | 42.5 | 42.5 | 30.0 |
| Second | Type | E | F | E | F | F2 | F3 | E |
| pressure | Thickness (μm) | 25 | 25 | 25 | 25 | 12 | 50 | 25 |
| sensitive | OH-containing monomer | Absent | Present | Absent | Present | Present | Present | Absent |
| adhesive | Gel fraction (wt %) | 90 | 88 | 90 | 88 | 88 | 88 | 90 |
| layer | G′₂₀ (×10⁴ Pa) | 22 | 20 | 22 | 20 | 20 | 20 | 22 |
| | G′₁₀₀ (×10⁴ Pa) | 8 | 11 | 8 | 11 | 11 | 11 | 8 |
| | G′₁₅₀ (×10⁴ Pa) | 7 | 10 | 7 | 10 | 10 | 10 | 7 |
| | G′₂₀/G′₁₀₀ | 2.8 | 1.8 | 2.8 | 1.8 | 1.8 | 1.8 | 2.8 |
| | G′₂₀/G′₁₅₀ | 3.1 | 2.0 | 3.1 | 2.0 | 2.0 | 2.0 | 3.1 |
| Laminated | Total thickness (μm) | 200 | 200 | 200 | 200 | 212 | 200 | 200 |
| pressure | G′₂₀ (×10⁴ Pa) | 17 | 17 | 23 | 23 | 17 | 19 | 26 |
| sensitive | G′₁₀₀ (×10⁴ Pa) | 0.9 | 1.2 | 1.4 | 1.7 | 0.9 | 1.4 | 1.7 |
| adhesive | G′₁₅₀ (×10⁴ Pa) | 0.5 | 0.8 | 0.9 | 1.3 | 0.5 | 1.1 | 1.3 |
| sheet | G′₂₀/G′₁₀₀ | 18.9 | 14.2 | 16.4 | 13.5 | 18.9 | 13.6 | 15.3 |
| | G′₂₀/G′₁₅₀ | 34.0 | 21.3 | 25.6 | 17.7 | 34.0 | 17.3 | 20.0 |
| Evaluation | Bubble reliability | good | good | good | good | good | good | good |
| | Display unevenness | good | good | good | moderate | good | moderate | moderate |

| | | Comparative | Comparative | Comparative | Comparative | Comparative |
|---|---|---|---|---|---|---|
| | | Example 1 | Example 2 | Example 3 | Example 4 | Example 5 |
| First | Type | C | A1 | B1 | E1 | F1 |
| pressure | Thickness (μm) | 175 | 200 | 200 | 200 | 200 |
| sensitive | OH-containing monomer | Present | 10 | 30 | — | 12 |
| adhesive | Gel fraction (wt %) | 52 | 38 | 47 | 90 | 88 |
| layer | G′₂₀ (×10⁴ Pa) | 18 | 17 | 23 | 22 | 20 |
| | G′₁₀₀ (×10⁴ Pa) | 3 | 0.7 | 0.9 | 8 | 11 |
| | G′₁₅₀ (×10⁴ Pa) | 2 | 0.4 | 0.7 | 7 | 10 |
| | G′₂₀/G′₁₀₀ | 6.0 | 24.3 | 25.6 | 2.8 | 1.8 |
| | G′₂₀/G′₁₅₀ | 9.0 | 42.5 | 32.9 | 3.1 | 2.0 |
| Second | Type | E | | | | |
| pressure | Thickness (μm) | 25 | | | | |
| sensitive | OH-containing monomer | Absent | | | | |
| adhesive | Gel fraction (wt %) | 90 | | | | |
| layer | G′₂₀ (×10⁴ Pa) | 22 | | | | |
| | G′₁₀₀ (×10⁴ Pa) | 8 | | | | |
| | G′₁₅₀ (×10⁴ Pa) | 7 | | | | |
| | G′₂₀/G′₁₀₀ | 2.8 | | | | |
| | G′₂₀/G′₁₅₀ | 3.1 | | | | |
| Laminated | Total thickness (μm) | 200 | 200 | 200 | 200 | 200 |
| pressure | G′₂₀ (×10⁴ Pa) | 18 | 17 | 23 | 22 | 20 |
| sensitive | G′₁₀₀ (×10⁴ Pa) | 3 | 0.7 | 0.9 | 8 | 11 |
| adhesive | G′₁₅₀ (×10⁴ Pa) | 2 | 0.4 | 0.7 | 7 | 10 |
| sheet | G′₂₀/G′₁₀₀ | 6.0 | 24.3 | 25.6 | 2.8 | 1.8 |
| | G′₂₀/G′₁₅₀ | 9.0 | 42.5 | 32.9 | 3.1 | 2.0 |
| Evaluation | Bubble reliability | good | bad | bad | good | good |
| | Display unevenness | bad | good | good | bad | bad |

In Comparative Examples 2 to 5 where a single-layer pressure sensitive adhesive sheet was used as a viewing-side pressure sensitive adhesive layer, the evaluation result of one of bubble reliability and display unevenness is “bad,” and thus both of these characteristics cannot be satisfied simultaneously. In Comparative Example 1, the first pressure sensitive adhesive layer disposed on the polarizing plate side of the laminated pressure sensitive adhesive sheet had a high storage elastic modulus at a high temperature, the overall laminated pressure sensitive adhesive sheet had a high storage elastic modulus at a high temperature, and thus display unevenness was observed.

On the other hand, in Examples 1 to 7, the evaluation results of both bubble reliability and display unevenness were “good.” In Examples 1 to 3 and Example 5 where the storage elastic modulus of the laminated pressure sensitive adhesive sheet at 150° C. was less than 1×10⁴, display unevenness was less visible as compared to Examples 4, 6 and 7 where the storage elastic modulus of the laminated pressure sensitive adhesive sheet at 150° C. was 1×10⁴ or more.

In both Example 3 and Example 4, the pressure sensitive adhesive sheet B is used as the first pressure sensitive adhesive layer provided on the polarizing plate side, but the pressure sensitive adhesive sheet E used as the second pressure sensitive adhesive layer in Example 3 has a lower storage elastic modulus at a high temperature as compared to the pressure sensitive adhesive sheet F used in Example 4. Accordingly, in Example 3, display unevenness is further suppressed probably because the storage elastic modulus of the overall laminated pressure sensitive adhesive sheet is lower as compared to Example 4.

Example 2 and Example 6 are identical in compositions of the first pressure sensitive adhesive layer and the second pressure sensitive adhesive layer, but probably because Example 2 and Example 6 are different in thickness ratio of the layers, the storage elastic modulus of the overall laminated pressure sensitive adhesive sheet at a high temperature is lower and display unevenness is further suppressed in Example 2.

From the above results, it is apparent that when a pressure sensitive adhesive having a low storage elastic modulus at a high temperature is provided on the polarizing plate side as the first pressure sensitive adhesive layer, and also the storage elastic modulus of the overall pressure sensitive adhesive sheet at a high temperature is low, occurrence of display unevenness can be further suppressed.

1. An optical film with pressure sensitive adhesive, which is to be disposed between a front transparent plate or a touch panel and an image display cell, wherein
the optical film with pressure sensitive adhesive comprises: an optical film including a polarizing plate; and a front-side pressure sensitive adhesive sheet provided on first main surface of the optical film,
the front-side pressure sensitive adhesive sheet includes a first pressure sensitive adhesive layer and a second pressure sensitive adhesive layer, wherein the first pressure sensitive adhesive layer is disposed in contact with the optical film, and the second pressure sensitive adhesive layer is disposed at the furthest from the optical film,
the first pressure sensitive adhesive layer has a storage elastic modulus of 9×10³ Pa or less at 150° C., and a ratio G′₂₀/G′₁₅₀ of 20 or more, where G′₂₀ is a storage elastic modulus at 20° C. and G′₁₅₀ is a storage elastic modulus at 150° C.,
the second pressure sensitive adhesive layer has a storage elastic modulus of 4×10⁵ Pa or less at 20° C., and a storage elastic modulus of 1×10⁴ Pa or more at 150° C.

2. The optical film with pressure sensitive adhesive according to claim 1, wherein the front-side pressure sensitive adhesive sheet has a storage elastic modulus of 1×10⁴ Pa or less at 150° C.

3. The optical film with pressure sensitive adhesive according to claim 1, wherein a gel fraction of a pressure sensitive adhesive of the second pressure sensitive adhesive layer is higher than a gel fraction of a pressure sensitive adhesive of the first pressure sensitive adhesive layer.

4. The optical film with pressure sensitive adhesive according to claim 3, wherein a difference between the gel fraction of the pressure sensitive adhesive of the first pressure sensitive adhesive layer and the gel fraction of the pressure sensitive adhesive of the second pressure sensitive adhesive layer is 15% by weight or more.

5. The optical film with pressure sensitive adhesive according to claim 1, wherein a gel fraction of a pressure sensitive adhesive of the first pressure sensitive adhesive layer is 55% by weight or less.

6. The optical film with pressure sensitive adhesive according to claim 1, wherein a gel fraction of a pressure sensitive adhesive of the second pressure sensitive adhesive layer is 75% by weight or more.

7. The optical film with pressure sensitive adhesive according to claim 1, wherein
a pressure sensitive adhesive of the first pressure sensitive adhesive layer is formed of a pressure sensitive adhesive composition containing an acrylic base polymer, and
the acrylic base polymer of the first pressure sensitive adhesive layer contains one or more kinds of monomer units selected from the group consisting of hydroxy group-containing monomer and nitrogen-containing monomer.

8. The optical film with pressure sensitive adhesive according to claim 1, wherein
a pressure sensitive adhesive of the second pressure sensitive adhesive layer is formed of a pressure sensitive adhesive composition containing an acrylic base polymer, and
the acrylic base polymer of the second pressure sensitive adhesive layer contains one or more kinds of monomer units selected from the group consisting of nitrogen-containing monomer and carboxy group-containing monomer.

9. The optical film with pressure sensitive adhesive according to claim 1, wherein the first pressure sensitive adhesive layer and the second pressure sensitive adhesive layer each contain silane coupling agent.

10. The optical film with pressure sensitive adhesive according to claim 1, wherein a thickness of the first pressure sensitive adhesive layer is 40 μm or more.

11. The optical film with pressure sensitive adhesive according to claim 1, wherein a thickness of the second pressure sensitive adhesive layer is 5 μm to 70 μm.

12. The optical film with pressure sensitive adhesive according to claim 1, wherein a ratio d₁/d₂ between a thickness d₁ of the first pressure sensitive adhesive layer and a thickness d₂ of the second pressure sensitive adhesive layer is 2 to 40.

13. An optical film with pressure sensitive adhesive according to claim 1, further comprising a cell-side pressure sensitive adhesive sheet provided on second main surface of the optical film.

14. An image display device comprising: an image display cell; an optical film with pressure sensitive adhesive; and a front transparent member, wherein
the transparent member is selected from a front transparent plate and a touch panel,
the optical film with pressure sensitive adhesive comprises: an optical film including a polarizing plate; and a front-side pressure sensitive adhesive sheet provided on first main surface of the optical film,
the optical film and the front transparent member are bonded together with the front-side pressure sensitive adhesive sheet interposed therebetween,
the front-side pressure sensitive adhesive sheet is a laminated pressure sensitive adhesive sheet including a first pressure sensitive adhesive layer and a second pressure sensitive adhesive layer, wherein the first pressure sensitive adhesive layer is bonded to the optical film, and the second pressure sensitive adhesive layer is bonded to the front transparent member,
the first pressure sensitive adhesive layer has a storage elastic modulus of 9×10³ Pa or less at 150° C., and a ratio G′₂₀/G′₁₅₀ of 20 or more, where G′₂₀ is a storage elastic modulus at 20° C. and G′₁₅₀ is a storage elastic modulus at 150° C.,
the second pressure sensitive adhesive layer has a storage elastic modulus of 4×10⁵ Pa or less at 20° C., and a storage elastic modulus of 1×10⁴ Pa or more at 150° C.
